(19) United States
(12) Patent Application Publication
(10) Pub. No.: US 2015/0356312 A1
(43) Pub. Date: Dec. 10, 2015

(54) INFORMATION PROCESSING SYSTEM, AND INFORMATION PROCESSING APPARATUS

(71) Applicants: Tadashi SATO, Kanagawa (JP); Susumu Fujioka, Kanagawa (JP)

(72) Inventors: Tadashi SATO, Kanagawa (JP); Susumu Fujioka, Kanagawa (JP)

(21) Appl. No.: 14/724,076

(22) Filed: May 28, 2015

(30) Foreign Application Priority Data
Jun. 9, 2014 (JP) 2014-118889

(51) Int. Cl. G06F 21/62; H04L 29/08

(52) U.S. Cl. CPC G06F 21/6218; H04L 67/1097

(57) ABSTRACT

An information processing system configurable with one or more information processing apparatuses includes a minutes manager to manage a minutes, a communication controller to control a reception of loading data receivable from an information terminal, the loading data attachable with attached information, a display controller to control displaying of the loading data received by the communication controller on a display, an agenda switching detector to detect an agenda switching for marking an agenda boundary between agendas based on the attached information attachable to the loading data received by the communication controller, and an agenda information generator to generate agenda information for the agenda marked with the agenda boundary by the agenda switching detector. The generated agenda information of the agenda-boundary-marked agenda is associable with the minutes managed by the minutes manager.

### CROSS-REFERENCE TO RELATED APPLICATION

This application claims priority pursuant to 35 U.S.C. §119(a) to Japanese Patent Application No. 2014-118889, filed on Jun. 9, 2014 in the Japan Patent Office, the disclosure of which are incorporated by reference herein in their entirety.

### BACKGROUND

1. Technical Field

The present invention relates to an information processing system, an information processing apparatus, and a program, and more particularly to an image processing system, an information processing apparatus, and a program to generate minutes of meeting.

2. Background Art

Electronic meeting or conference systems configured with one or more electronic information boards and meeting management servers are known. When these electronic meeting systems are used for meetings, resource files retained by information terminals, and resource files retained by meeting management servers can be transmitted an to electronic information board to display data of the resource files on the electronic information board. A meeting can be proceeded by switching displayed data of the resource files, and further, by writing information manually on the displayed data by utilizing a touch pen or the like as required. Further, data displayed on the electronic information board and/or manually-written data during the meeting can be stored in the meeting management server as data files, and a path to a file storing destination unit can be reported to meeting participants.

For example, a meeting information searching system that users can search meeting information is proposed. In this meeting information searching system, a transcriber presses a switch such as a button when one agenda is started and ended. Upon receiving a signal from the switch, the start and end time information of the agenda can be generated, and then the time information can be stored in an agenda manager.

However, as to this electronic meeting system, a dedicated device is required to notify each agenda raised in a meeting to the electronic meeting system, which means some operational works are required. For example, a dedicated switch can be disposed for the electronic meeting system to notify an agenda switching during a meeting. However, this configuration may not efficiently sort resources for each of agendas when generating the minutes of meeting. Further, the agenda switching may not be recorded if the transcriber forgets to press the switch when the agenda switching occurs. The time information for each agenda can be manually registered to the electronic meeting system after the meeting, but this configuration still requires an editing work after the meeting, which requires some operational works.

### SUMMARY

In one aspect of the present invention, an information processing system configurable with one or more information processing apparatuses is devised. The information processing system includes a minutes manager to manage a minutes, a communication controller to control a reception of loading data receivable from an information terminal, the loading data attachable with attached information, a display controller to control displaying of the loading data received by the communication controller on a display, an agenda switching detector to detect an agenda switching for marking an agenda boundary between agendas based on the attached information attachable to the loading data received by the communication controller, and an agenda information generator to generate agenda information for the agenda marked with the agenda boundary by the agenda switching detector. The generated agenda information of the agenda-boundary-marked agenda is associable with the minutes managed by the minutes manager.

In another aspect of the present invention, an information processing system configurable with one or more information terminals and one or more information processing apparatuses is devised. The information processing system includes a minutes manager to manage a minutes, a communication controller to control a reception of loading data from the one or more information terminals, the loading data attachable with attached information, a display controller to control displaying of the loading data received by the communication controller on a display, an agenda switching detector to detect an agenda switching for marking an agenda boundary between agendas based on the attached information attachable to the loading data received by the communication controller; and an agenda information generator to generate agenda information for the agenda marked with the agenda boundary by the agenda switching detector. The generated agenda information of the agenda-boundary-marked agenda is associable with the minutes managed by the minutes manager. The minutes manager, the communication controller, the display controller, the agenda switching detector, and the agenda information generator are operable on the one or more information processing apparatuses.

In another aspect of the present invention, an information processing apparatus is devised. The information processing apparatus includes a communication controller to control a reception of loading data from an information terminal, the loading data attachable with attached information, a display controller to control displaying of the loading data received by the communication controller on a display, an agenda switching detector to detect an agenda switching for marking an agenda boundary between agendas based on the attached information attachable to the loading data received by the communication controller, and a notifying unit to notify the detected agenda switching to a server when the agenda switching detector detects the agenda switching, The server generates agenda information of the agenda-boundary-marked agenda, and associates the generated agenda information with a minutes for managing the generated agenda information.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is an example of a network environment of an electronic meeting system according to one or more example embodiments;

FIG. 2 is a hardware configuration of an electronic information board in the electronic meeting system of FIG. 1;

FIG. 3 is a hardware configuration of a meeting management server in the electronic meeting system of FIG. 1;

FIG. 4 (FIGS. 4A and 4B) is an example of functional modules of the electronic meeting system of FIG. 1;

FIG. 5 is a flowchart showing the steps of a process of detecting and notifying an agenda switching executable by the electronic information board according to one or more example embodiments;

FIG. 6 illustrates an example of relationships of information received by and transmitted from the electronic information board, and meetings and agendas according to one or more example embodiments;

FIG. 7 is a flowchart showing the steps of a process of meeting management executable by the meeting management server;

FIG. 8 shows an example of management structure of minutes, agenda documents, meeting resources managed by the meeting management server;

FIG. 9 (FIGS. 9A and 9B) is an example of communication flows of data between apparatuses in the electronic meeting system without setting confidentiality;

FIG. 10 (FIGS. 10A and 10B) is an example of communication flows of data between apparatuses with setting confidentiality, in which the access right is granted to only one or more participants of an agenda;

FIG. 11 (FIGS. 11A and 11B) is an example of communication flows of data between apparatuses with setting confidentiality, in which the access right is granted to only one or more speakers of an agenda using speaker recognition technologies; and

FIG. 12 (FIGS. 12A and 12B) is an example of communication flows of data between apparatuses with setting confidentiality, in which a storing destination unit is selectively set depending on confidentiality setting.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, one or more apparatuses or systems according to one or more example embodiments are described hereinafter.

A description is given of an information processing system including one or more information processing apparatuses. For example, an electronic meeting or conferences system including an electronic information board having a display and an input apparatus, and a meeting management server is described as one example of the information processing system. In this description, the term of the meeting may mean conference or other synonyms.

Further, a description is given of an information processing system including one or more information terminals, and one or more information processing apparatuses. For example, an electronic meeting system including one or more mobile information terminals, an electronic information board, and a meeting management server is described as one example of the information processing system.

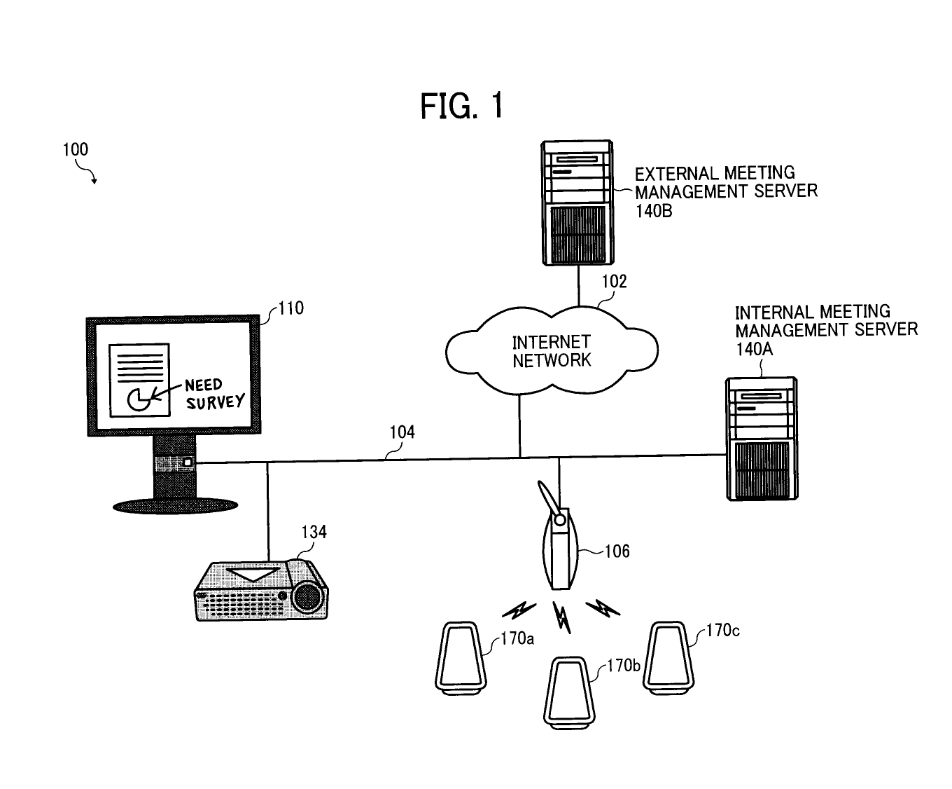

FIG. 1 is an example of a network environment of an electronic meeting system 100 including an electronic information board 110, and a meeting management server 140 according to one or more example embodiments. The network environment of FIG. 1 includes, for example, an Internet network 102, and an internal network 104 such as a local area network (LAN) but not limited hereto. The electronic information board 110 and the meeting management server 140 are disposable on the internal network 104. The Internet network 102 is a public network connectable by transmission control protocol/Internet protocol (TCP/IP). The internal network 104 is, for example, a network disposed in entities or organizations such as government agencies, universities, companies, or the like. As to the network environment of FIG. 1, the internal network 104 is connectable to the Internet network 102 via a router.

Specifically, the electronic information board 110, and an internal meeting management server 140A disposed inside an entity or organization can be disposed on the internal network 104. Further, an access point 106 is connectable to the internal network 104. The access point 106 is connectable wirelessly with a plurality of mobile information terminals 170a to 170c. Each of the mobile information terminal 170 can be a smartphone, a tablet terminal, a personal digital assistance (PDA), a feature phone or the like. Each of the mobile information terminals 170a to 170c can access the internal network 104 via the access point 106, with which means the mobile information terminals 170a to 170c can communicate with the electronic information board 110 and the internal meeting management server 140A.

Users can use the mobile information terminals 170 to transmit one or more resource files (resource data) to the electronic information board 110 as data displayable (i.e., loadable) on the electronic information board 110 in view of a progress of a meeting along the time line. For example, data such as resource data can be displayed (i.e., loaded) on a display or screen of the electronic information board 110. Further, users can write information or data manually on the display or screen of the electronic information board 110 while the electronic information board 110 is displaying the data and not displaying the data. Further, users can use the mobile information terminals 170 to transmit a request to the meeting management server 140A. For example, users can transmit a participation request to a meeting, and an acquiring request of minutes, an agenda document, a meeting resource (resource file used for a meeting), and/or a resource file which may be added with manually-written information, to be described later. With this configuration, users can participate one or more desired meetings, and can access one or more desired minutes, agenda documents, and meeting resources.

In this description, both of the transmission and acquiring request of a resource file (resource data) can be performed by the same mobile information terminal 170 using the same user identification information. However, a terminal that a user uses to transmit a resource file (resource data), and a terminal that the user uses to transmit an acquiring request of minutes, agenda document, and meeting resource can be the same or different terminals.

As to the network environment of FIG. 1, an external meeting management server 140B is further disposed on the Internet network 102, wherein the external meeting management server 140B is disposed outside an entity or organization. The external meeting management server 140B can be used by persons not belonging to the entity or organization to view meeting resources and to acquire meeting resource files (resource data).

As to the network environment of FIG. 1 including the Internet network 102 and the internal network 104, the mobile information terminals 170 can access the network disposed of the electronic information board 110 and the internal meeting management server 140A, but the network environment is not limited to this configuration. Further, as to the network environment of FIG. 1, the internal meeting management server 140A and the external meeting management server 140B are employed as servers having different levels of openness to the public (i.e., confidentiality level).

The meeting management server 140 can be operated on-premises, or can be provided as service such as public cloud, community cloud, private cloud such as software as a service (SaaS), and platform as a service (PaaS) or the like. Typically, the internal meeting management server 140A utilized inside an entity or organization has a lower openness to the public (i.e., server can be accessed by persons having specific access right) while the external meeting management server 140B utilized outside an entity or organization has a higher openness to the public (i.e., server can be accessed by persons without using specific access right). The level of openness to the public of a server may be set higher as a sharing range of resources with others becomes broader.

In the following description, it is assumed that the electronic information board 110 and the mobile information terminal 170 communicate with the internal meeting management server 140A whereas the external meeting management server 140B communicates only with the internal meeting management server 140A. Hereinafter, when the term of the “meeting management server 140” is used, the “meeting management server 140” means the internal meeting management server 140A except otherwise is indicated.

As to the electronic meeting system 100, while users transmit resource files (resource data) from the mobile information terminals 170 to display data on the electronic information board 110, the meeting management server 140 can generate the minutes of meeting. For example, one meeting can be held for discussing a plurality of agendas, in which participants of each of the agendas may become different, and different confidentiality can be set for each of the agendas, and thereby different security management is preferably performed for each of the agendas.

As to the meetings, it is desired to manage the minutes and the meeting resources by marking a boundary between agendas. When a boundary between agendas are marked and managed by conventional technologies, a device to notify that a new agenda is raised during a meeting to the electronic meeting system is required. For example, a dedicated switch can be disposed to notify that an agenda switching occurs during a meeting to the electronic meeting system, and time information of each of agendas can be registered manually to the electronic meeting system after the meeting. However, these methods are not efficient for marking a boundary between the agendas and generating the minutes of meeting for each of the agendas. Further, if the dedicated switch is not pressed by mistake such as forgetting when an agenda is switched, an agenda switching cannot be recorded. Further, when the electronic meeting system of conventional technologies are used, even if confidentiality levels of meeting resources are different for each of the agendas, the access right to the meeting resources cannot be selectively assigned to members who requires to access the meeting resources.

As to the electronic meeting system 100 according to one or more example embodiments, the electronic meeting system 100 includes, for example, the electronic information board 110, and the meeting management server 140. In the electronic meeting system 100, an agenda switching can be detected when the electronic information board 110 receives a resource file from the mobile information terminal 170, and the meeting management server 140 can generate an agenda document for each agenda, and can associate the agenda document with the minutes of meeting. With this configuration, the minutes of meeting can be generated by marking a boundary between agendas discussed in a meeting based on the detection of the agenda switching.

The meeting resources such as resource files (resource data) used for each of the agendas can be transmitted to the meeting management server 140. Preferably, the confidentiality of the meeting resources can be managed for each of the detected agendas, and an access control of the meeting resources can be performed for each of the detected agendas instead of each of the meeting resources. With this configuration, when the confidentiality levels are different for each of agendas discussed in a meeting, the access right to the meeting resources of each of the agendas can be selectively assigned to one or more persons that are required to access the meeting resources.

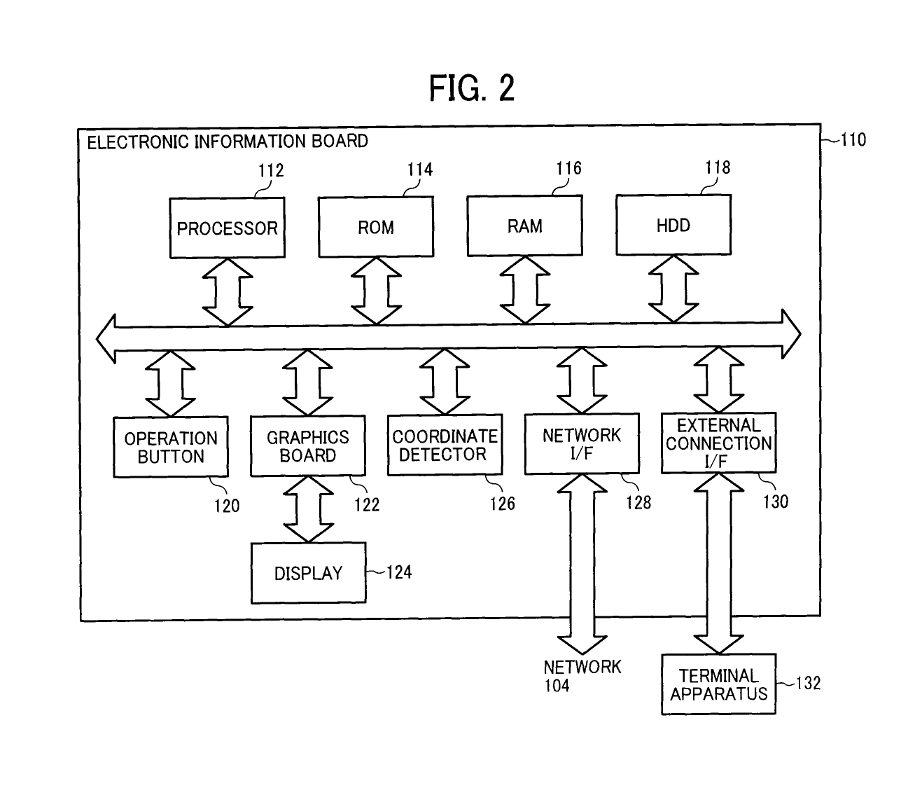

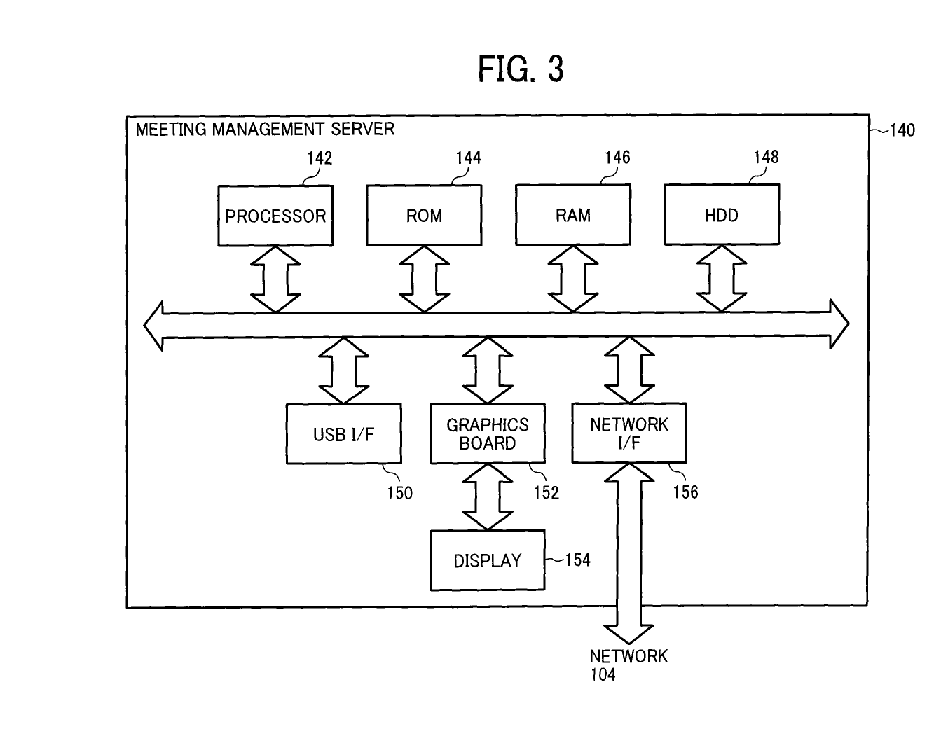

A description is given of hardware configuration of the electronic information board 110 and the meeting management server 140 according to one or more example embodiments with reference to FIGS. 2 and 3.

FIG. 2 is a hardware configuration of the electronic information board 110. The electronic information board 110 includes, for example, a processor 112, a read only memory (ROM) 114, a random access memory (RAM) 116, a hard disk drive (HDD) 118, an operation button 120, a graphics board 122, a display 124, a coordinate detector 126, a network interface (I/F) 128, and an external connection interface (I/F) 130.

The processor 112 is a computing device that controls various processing performable by the electronic information board 120. The processor 112 can be a central processing unit (CPU) or micro processing unit (MPU) employing various processors such as PENTIUM (registered trademark). The ROM 114 is a non-volatile memory that stores a boot program such as basic input/output system (BIOS) and others.

The RAM 116 is a volatile memory or a non-volatile memory used as a working area of software program executable by the processor 112. Under the management of an operating system (OS), the processor 112 can execute object-oriented programming languages such as C, C++, Java (registered trademark), JavaScript (registered trademark), Perl, Ruby, Python, or legacy programming languages such as machine language, assembler language to control functional units of the electronic information board 110 to be described later.

The HDD 118 is a non-volatile memory of large capacity, which stores various operating systems (OS) such as WINDOWS (registered trademark), UNIX (registered trademark), LINUX (registered trademark), Android (registered trademark) used for controlling the entire system of the electronic information board 110. Further, the HDD 118 stores various data such as device drivers of the graphics board 122, the display 124, and the coordinate detector 126, and software programs for main processing. The software program can be stored in computer-readable storage medium such as a compact disk read only memory (CD-ROM), a compact disk rewritable (CD-RW), a digital versatile disk read only memory (DVD-ROM), DVD recording only/rewritable (DVD-R/RW), a flexible disk, electrically erasable and programmable read only memory (EEPROM), erasable programmable read only memory (EPROM), a memory card or stick such as USB memory, a memory chip, a mini disk (MD), a magneto optical disc (MO), magnetic tape, a hard disk in a server, a solid state memory device or the like, and the software program can be installed to the electronic information board 110. Further, the software program can be installed to the electronic information board 110 via a network.

The operation button 120 includes one or more hardware buttons disposed on an outer face of a casing of the electronic information board 110, which are operable by users. The graphics board 122 is a processing circuit that processes data drawn on the display 124, and can be configured with, for example, a video RAM (VRAM) that retains video image, and image connection terminals connectable to the display 124. The display 124 is a display apparatus that displays data drawn or generated by the graphics board 122.

The coordinate detector 126 is a detector that detects an object such as a pen and/or a finger contacting or coming close to the display 124. The coordinate detector 126 can be a touch panel having a capacitive sensor that detects capacitance changeable by a contact of the object, or a touch panel having a pressure sensor that detects contact pressure of the object. Further, the coordinate detector 136 can be an optical detector that detects blocking of light, emitted in parallel along a face of the display 124 from one direction or two directions (height and length directions) to detect contacting or coming close of the object to the display 124.

The network interface 128 is an interface that connects the electronic information board 110 to the network 104, and can be a physical interface such as a local area network (LAN) cable connector, a modular cable connector or the like. The external connection I/F 130 is an interface that connects a terminal apparatus 132 (external apparatus) such as a personal computer to the electronic information board 110, and can be a physical interface such as a video graphics array (VGA) input connector, a high-definition multimedia interface (HDMI: registered trademark) port, a universal serial bus (USB) port or the like.

As to the hardware configuration illustrated in FIG. 2, the information processing apparatus such as the electronic information board 110 includes a display apparatus such as the display 124, an input apparatus such as the operation button 120 and the coordinate detector 126, and a computing apparatus in the same casing. However, the hardware configuration of the electronic information board is not limited hereto. In another configuration, an electronic information board can be configured with a plurality of apparatuses connectable with each other such as a display apparatus, an input apparatus, and a computing apparatus, which are independent apparatuses mutually. Further, the information processing system can include a display apparatus such as a projector 134 (FIG. 1), an input apparatus, a network interface, or any types of apparatus that can be connected.

A description is given of a hardware configuration of the meeting management server 140. FIG. 3 is a hardware configuration of the meeting management server 140 according to one or more example embodiments. The meeting management server 140 includes, for example, a processor 142, a read only memory (ROM) 144, a random access memory (RAM) 146, a hard disk drive (HDD) 148, an universal serial bus interface (I/F) 150, a graphics board 152, a display 154, and a network interface (I/F) 156.

The processor 142 is a computing device that controls various processing performable by the meeting management server 140. The ROM 144 is a non-volatile memory that stores a boot program such as basic input/output system (BIOS) and others. The RAM 146 is a volatile memory or a non-volatile memory used as a working area of software program executable by the processor 142. Under the management of an operating system (OS), the processor 142 loads and executes programs described by programming languages to devise or implement functional units of the meeting management server 140 to be described later.

The HDD 148 is a non-volatile memory of large capacity, which stores various operating systems (OS) used for controlling the entire system of the meeting management server 140. Further, the HDD 148 stores various data such as device drivers of the graphics board 152, and the display 154, and software programs used for main processing. The USB interface 150 is an interface that connects the meeting management server 140 with a USB device such as a mouse, a keyboard, a printer or the like. The graphics board 152 is a processing circuit that processes data drawn on the display 154. The display 154 is a display apparatus that displays data drawn or generated by the graphics board 152. The network interface 156 is a physical interface that connects the meeting management server 140 to the network 104.

The internal meeting management server 140A and the external meeting management server 140B can be configured with the same or similar configuration. The mobile information terminal 170 can be configured with a hardware configuration that is the same or similar configuration of FIG. 3, and includes, for example, a processor, a read only memory (ROM), a random access memory (RAM), a hard disk drive (HDD), and a network interface as required.

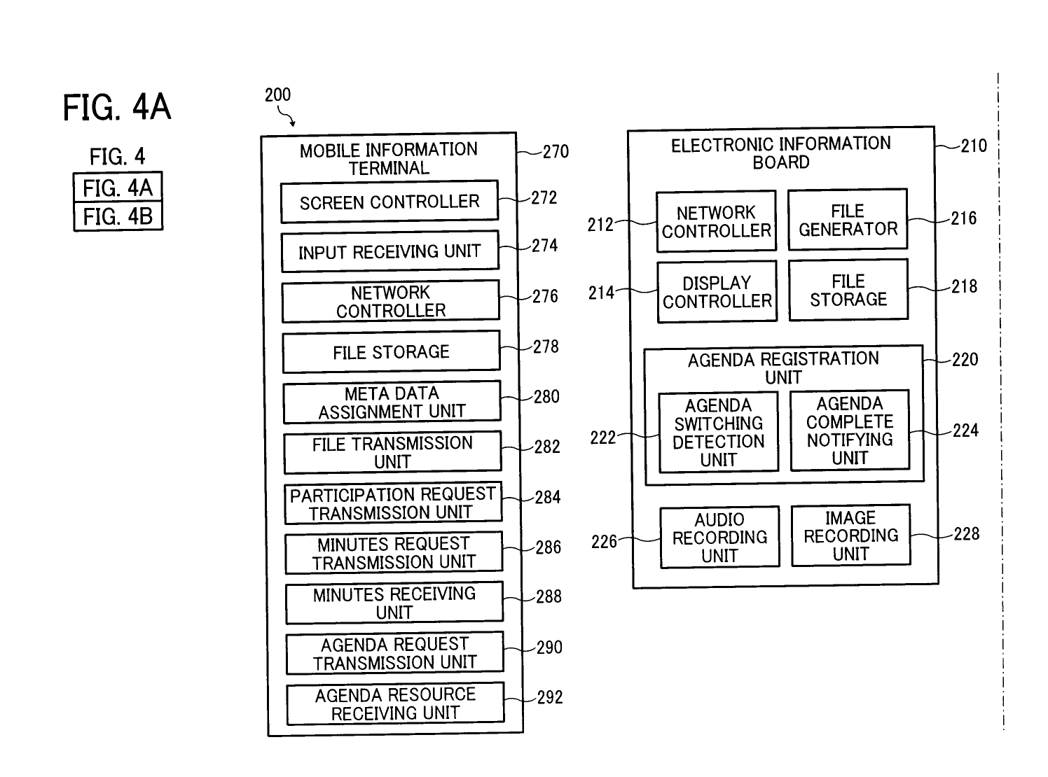

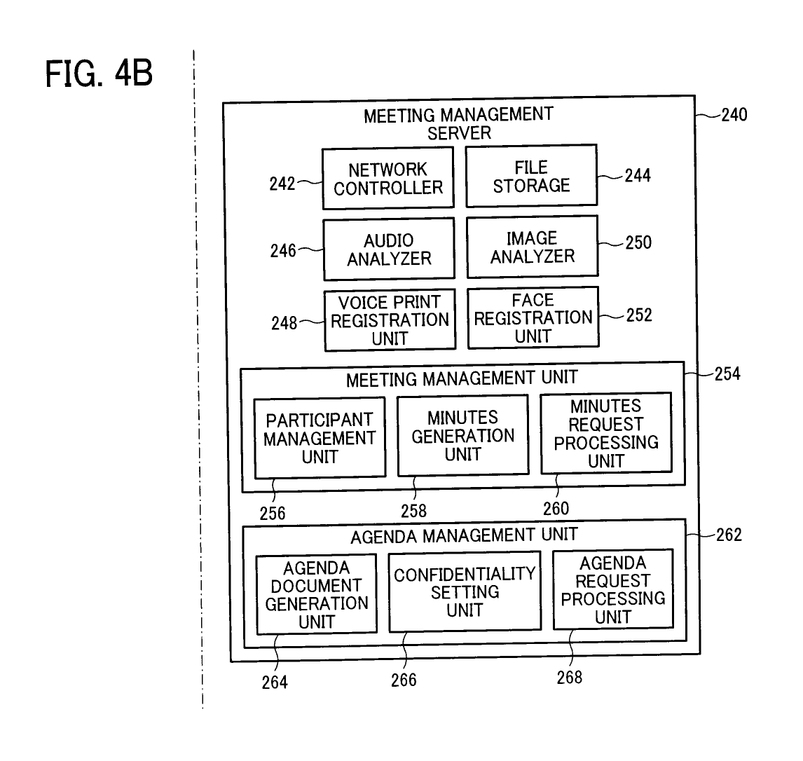

A description is given of a functional configuration of the electronic information board 110 according to one or more example embodiments with reference to FIG. 4 (FIGS. 4A and 4B). FIG. 4 illustrates a functional module 200 implementable by the electronic meeting system 100. The functional module 200 of the electronic meeting system 100 includes a functional module 210 implementable on the electronic information board 110, a functional module 240 implementable by the meeting management server 140, and further a functional module 270 implementable by the mobile information terminal 170 as illustrated in FIG. 4.

A description is given of a functional configuration of the electronic information board 110 with reference to FIG. 4. As illustrated in FIG. 4, the functional module 210 implementable by the electronic information board 110 includes, for example, a network controller 212, a display controller 214, a file generator 216, a file storage 218, an agenda registration unit 220, an audio recording unit 226, and an image recording unit 228.

The network controller 212 includes a network interface used for communicating with an external apparatus or device such as the meeting management server 140, and the mobile information terminal 170. The network controller 212 can control a process of receiving resource files from the mobile information terminals 170. The network controller 212 can be used as a communication controller according to one or more example embodiments. For example, the resource file transmitted from the mobile information terminal 170 may mean a resource file transmitted to the electronic information board 110 from the mobile information terminal 170, a resource file transmitted to the electronic information board 110 from a document data management system in response to an instruction of the mobile information terminal 170, or a resource file that the electronic information board 110 retrieves from a file server and/or the document data management system in response to an instruction of the mobile information terminal 170.

The display controller 214 can perform a display control based on a resource file, and input data written manually on the electronic information board 110. The display controller 214 can perform a display control of a display based on a resource file received by the network controller 212. The display controller 214 can be used as a display controller according to one or more example embodiments.

The file generator 216 can generate file data of images displayed by the display controller 214 (i.e., image data loaded to the electronic information board 110). The file generator 216 can convert the image, displayed on the display 124 by the display controller 214, and data input to the display 124, by using an input device such as a touch panel, to data having a given format such as still image format and movie image format to generate a new resource file.

The file storage 218 stores various resource files such as resource files transmitted from the mobile information terminal 170, and resource files generated by the file generator 216. For example, the file storage 218 is implementable by a storage area of the HDD 118 of the electronic information board 110.

The agenda registration unit 220 can detect an occurrence of agenda switching, and transmit resource files related to each agenda retained by the agenda registration unit 220 to the meeting management server 140 as the meeting resource. The agenda registration unit 220 includes, for example, an agenda switching detection unit 222, and an agenda complete notifying unit 224 as illustrated in FIG. 4.

The agenda switching detection unit 222 can analyze attached information attached to the received resource files, and detect an agenda switching based on the attached information. The agenda switching detection unit 222 can be used as an agenda switching detector according to one or more example embodiments. The attached information used for detecting the agenda switching is, for example, meta data attachable to main data of resource files. The meta data is, for example, bibliographic information. Further, the attached information is, for example, sender identification information used for identifying senders of resource files.

As to the meta data, users can embed the meta data in the resource files by using the mobile information terminals 170 when the resource files are to be transmitted from the mobile information terminals 170 to the electronic information board 110, or users can embed the meta data in the resource files when the users generate the resource files.

Further, the meta data can be embedded as a specific code indicating the agenda switching. For example, specific codes instructing the agenda switching can be set in the resource files, to be transmitted from the mobile information terminal 170, as default setting, and the specific codes can be deleted at the mobile information terminals 170 when the resource files are to be transmitted from the mobile information terminal 170 with an instruction of continuation of the same agenda. Further, the specific codes instructing the agenda switching may not be embedded as the default setting, but the specific codes instructing the agenda switching can be added only when the resource files are to be transmitted from the mobile information terminals 170 with an instruction of the agenda switching.

Further, the meta data can use general bibliographic information such as a document generating person, or a combination of the above described information. For example, when a plurality of resource files transmitted continuously from the same document generating person, it may be determined that the plurality of resource files relate to the same agenda. Further, when one document generating person transmits one or more resource files previously, and another document generating person transmits one or more resource files currently, it can be determined that the agenda switching has occurred. Further, the agenda switching can be detected by setting other criteria.

Further, the meta data can be sender identification information used for identifying the senders of the resource files. For example, a meeting can be designed to switch an agenda when a chairperson of a meeting transmits a resource file, in which it can be determined that the agenda is switched if the sender of the resource file is the chairperson. With this configuration, the agenda switching can be notified to the electronic meeting system 100 easily if the chairperson proceeds the meeting based on a pre-set proceedings of the meeting.

When the agenda switching detection unit 222 detects the agenda switching, the agenda complete notifying unit 224 notifies a completion of the in-progress agenda to the meeting management server 140. Preferably, the agenda complete notifying unit 224 can transmit an agenda completion notice with one or more resource files related to the previous agenda. The agenda complete notifying unit 224 can be used as a notifying unit according to one or more example embodiments. For example, when the agenda switching is detected, the agenda complete notifying unit 224 can transmit one or more resource files used for the previous agenda before switching the agenda to the meeting management server 140 with an agenda completion notice.

The audio recording unit 226 may include a sound card connectable to a microphone, disposed internally or externally to the electronic information board 110, to record audio during a meeting to generate audio data. The image recording unit 228 may include a video board connectable to a camera, disposed internally or externally to the electronic information board 110, to record image during a meeting to generate image data. The audio data and image data can be managed with the unit of each agenda. Preferably, a boundary between the adjacent agendas is marked for a plurality of agendas by detecting the agenda switching using the agenda switching detection unit 222, and then an audio file and an image file can be generated. The audio recording unit 226 and the image recording unit 228 can be respectively used as an audio recorder and an image recorder according to one or more example embodiments. The audio file and the image file, respectively generated by the audio recording unit 226 and the image recording unit 228, can be stored in the file storage 218.

A description is given of a functional configuration of the meeting management server 140 with reference to FIG. 4. The functional module 240 implementable by the meeting management server 140 includes, for example, a network controller 242, a file storage 244, an audio analyzer 246, a voice print registration unit 248, an image analyzer 250, a face registration unit 252, a meeting management unit 254, and an agenda management unit 262 as illustrated in FIG. 4.

The network controller 242 includes a network interface used for communicating with an external apparatus or device such as the electronic information board 110, and the mobile information terminal 170. The network controller 242 controls a process of receiving an agenda completion notice indicating the agenda switching from the electronic information board 110 based on the attached information attached to the resource files. The network controller 242 can be used as a communication controller according to one or more example embodiments.

The file storage 244 can store the minutes generated for each of meetings, agenda documents generated for each of agendas, and meeting resources (resource data) used for each of agendas during meetings and received from the electronic information board 110, in which the agenda document can be associated or linked to the minutes and managed, and the meeting resource can be associated or linked to the agenda document and managed. For example, the file storage 244 is implementable by a storage area of the HDD 148 of the meeting management server 140.

The audio analyzer 246 can analyze audio files of each of the agendas received from the electronic information board 110, in which the audio analyzer 246 compares audio data in the concerned agenda, and voice print data registered in the voice print registration unit 248 to identify one or more speakers that have spoken during the concerned agenda. The voice print registration unit 248 can register voice print data of each of users (i.e., persons) in advance, in which the voice print data can be generated by extracting features from audio data of speakers (i.e., persons). The process of identifying speakers can be performed by utilizing known speaker recognition technologies.

The image analyzer 250 can analyze image files of each of the agendas received from the electronic information board 110, in which the image analyzer 250 compares image data in the concerned agenda, and face data registered in the face registration unit 252 to identify one or more writers that have written data manually on the display during the concerned agenda. The face registration unit 252 can register face image data of each one of users (i.e., persons) in advance, in which the face image data can be generated by extracting features from face image data of writers (i.e., persons). The process of identifying the face can be performed by utilizing known face recognition technologies. Further, the field of view (angle) of a camera disposed for the electronic information board 110 can be set to a given angle so that persons in front of a screen of the electronic information board 110 can be captured.

The meeting management unit 254 can manage the minutes for each of meetings by associating the minutes with agenda documents generated for each of agendas discussed in a meeting. The meeting management unit 254 can be used as a minutes manager according to one or more example embodiments. The meeting management unit 254 includes, for example, a participant management unit 256, a minutes generation unit 258, a minutes request processing unit 260 as illustrated in FIG. 4.

The participant management unit 256 can manage participants of on-going meetings, and participants that have participated the concerned agendas in meetings. The participant management unit 256 can be used as a participant manager according to one or more example embodiments. The minutes generation unit 258 can generate a minutes when a meeting is started and when a meeting is newly registered, and can update the minutes during the meeting as required. The minutes includes, for example, bibliographic information (e.g., meeting identifier (ID), organizer, participants, meeting place, and date useable for identifying the meeting), and association information to associate with the related agenda documents. The minutes request processing unit 260 can provide a list of minutes, and a list of associated or linked agenda documents when a review request (acquiring request) of the minutes is received or detected.

The agenda management unit 262 can manage agenda documents for each of agendas, and associate the agenda documents and the meeting resources used for each of the agendas. The agenda management unit 262 includes, for example, an agenda document generation unit 264, a confidentiality setting unit 266, an agenda request processing unit 268 as illustrated in FIG. 4.

When the agenda switching is detected by the agenda switching detection unit 222 of the electronic information board 110, the agenda document generation unit 264 can generate agenda documents for each of agendas by associating the generated agenda documents with the minutes managed by the meeting management unit 254. The agenda document generation unit 264 can be used as an agenda information generator according to one or more example embodiments. The agenda document generation unit 264 can associate the agenda documents, and the meeting resources used for the concerned agendas and transmitted from the electronic information board 110.

The agenda document includes, for example, an agenda identifier (ID) used for identifying each of the agendas, and bibliographic information (e.g., meeting identifier (ID) used for associating with the meeting and the minutes used as a parent, meeting organizer, speakers of agenda, participants of agenda, speakers, writers, file senders, time), and association information to associate with the related meeting resource, text input by a transcriber, and text of spoken contents generated by recognizing audio data.

The confidentiality setting unit 266 can set confidentiality property for each of agendas when the agenda switching detection unit 222 of the electronic information board 110 detects the agenda switching. The confidentiality setting unit 266 can be used as a confidentiality setting unit according to one or more example embodiments. The confidentiality property includes, for example, confidentiality levels (e.g., high, low) indicating the level of confidentiality. Further, the confidentiality property can include information indicating a disclosure allowable range (group, department, company, public), and information indicating disclosure allowable persons or posts (section chief, department manager, rank-and-file employee).

When a review request (acquiring request) of the concerned agenda is received or detected, the agenda request processing unit 268 can provide agenda documents, a list of meeting resources associated to each of the agendas, and data of specific meeting resources. The agenda request processing unit 268 can receive an acquiring request of the meeting resources stored in the file storage 244 of the meeting management server 140. If it is determined that an agenda requester (i.e., person) has the access right to the concerned agenda associated with the acquiring-requested meeting resources, the meeting resources can be provided to the agenda requester. The agenda request processing unit 268 can be used as a request processing unit according to one or more example embodiments.

Further, the agenda request processing unit 268 can determine the access right of an agenda requester based on at least one of information of speaker(s) of the requested agenda, information of writer(s) of the requested agenda, information of participants of the requested agenda, information of sender(s) of resource file(s) of the requested agenda, and any combinations of these information. The determination method of the access right is not limited any specific methods. For example, the access right can be set based on one or more given criteria. For example, as to an agenda having a “high” confidentiality level, the access right can be granted only to participants of the concerned agenda such as any one of speakers, writers, and resource file senders of the concerned agenda.

The meeting resources can be stored in the file storage 244 of the meeting management server 140, which can be used as a storing destination unit of data and information. Preferably, the storing destination unit for storing minutes, agenda documents, and meeting resources can be determined or set based on the confidentiality property set to the concerned agenda by utilizing the confidentiality setting unit 266 to be described later. In this storing destination determination process, the storing destination unit can be determined in view of openness to the public of a storage area of the storing destination unit. For example, meeting resources set with a first confidentiality level (i.e., higher confidentiality level) can be stored in the storing destination unit having a lower openness to the public (i.e., security level is high) such as the internal meeting management server 140A, and meeting resources set with a second confidentiality level (i.e., lower confidentiality level) can be stored in the storing destination unit having a higher openness to the public (i.e., security level is low) such as the external meeting management server 140B, in which the second confidentiality level is lower than the first confidentiality level. Therefore, the openness to the public of the storage area of the internal meeting management server 140A (first storing destination unit) is lower than openness to the public of the storage area of the external meeting management server 140B (second storing destination unit).

For example, as to the network environment of FIG. 1, meeting resources of agendas set with the high confidentiality level can be stored in the file storage 244A of the internal meeting management server 140A, and meeting resources of agendas set with the lower confidentiality level can be stored in the file storage 244B of the external meeting management server 140B having higher openness to the public. With this configuration, information security can be effectively secured for the meeting resources having the higher confidentiality level while saving load capacity of a server having lower openness to the public utilized inside an entity or organization.

As to the configuration of FIG. 4, each of the functional units of the meeting management server 140 is implementable by the single meeting management server 140. However, the functional units of the meeting management server 140 can be implemented by using a plurality of computing apparatuses disposed separately, and each of the functional units can be implemented separately by any one of a plurality of information processing apparatuses configuring a server function that manages meetings.

A description is given of a functional configuration of the mobile information terminal 170 with reference to FIG. 4. The functional module 270 implementable by the mobile information terminal 170 includes, for example, a screen controller 272, an input receiving unit 274, a network controller 276, a file storage 278, a meta data assignment unit 280, a file transmission unit 282, a participation request transmission unit 284, a minutes request transmission unit 286, a minutes receiving unit 288, an agenda request transmission unit 290, and an agenda resource receiving unit 292 as illustrated in FIG. 4.

The screen controller 272 can perform a display control of a screen or display of the mobile information terminal 170. The input receiving unit 274 can receive input operations to a touch pad and/or operation buttons of the mobile information terminal 170. The network controller 276 includes a network interface to connect the mobile information terminal 170 to external apparatuses such as the electronic information board 110, and the meeting management server 140. The file storage 278 can store resource files to be transmitted to, for example, the electronic information board 110.

When the meta data is used as the attached information, the meta data assignment unit 280 can assign information indicating an agenda switching or an agenda continuation to the meta data of resource files to be transmitted in response to an input operation by a user. The meta data assignment unit 280 can be used as an assignment unit according to one or more example embodiments. The file transmission unit 282 can read one or more designated resource files from the file storage 278, and can transmit the one or more designated resource files to the electronic information board 110. The file transmission unit 282 can transmit the one or more resource files with sender identification (ID) information (e.g., address, user identifier (ID), session information) to use the sender identification (ID) information as the attached information.

The participation request transmission unit 284 can instruct the network controller 276 to transmit a participation request requesting a participation to a designated meeting to the meeting management server 140. The minutes request transmission unit 286 can instruct the network controller 276 to transmit an acquiring request of a designated minutes of meeting to the meeting management server 140. The minutes receiving unit 288 can instruct the network controller 276 to receive the minutes transmitted as a response of the acquiring request. The agenda request transmission unit 290 can instruct the network controller 276 to transmit an acquiring request of agenda documents, and meeting resources of a designated meeting and a designated agenda. The agenda resource receiving unit 292 can instruct the network controller 276 to receive the agenda documents and the meeting resources transmitted as a response of the acquiring request.

The above described each functional units of the mobile information terminal 170 is implementable by utilizing OS, device drivers, browsers, and/or applications of the mobile information terminal 170. For example, when the meeting management server 140 activates a web application configuring an electronic meeting system, the meta data assignment unit 280, the file transmission unit 282, and the above request transmission units 284 to 292 can be implemented by operations on a browser of the mobile information terminal 170 based on hypertext markup language (HTML) data (screen data) transmitted from the meeting management server 140.

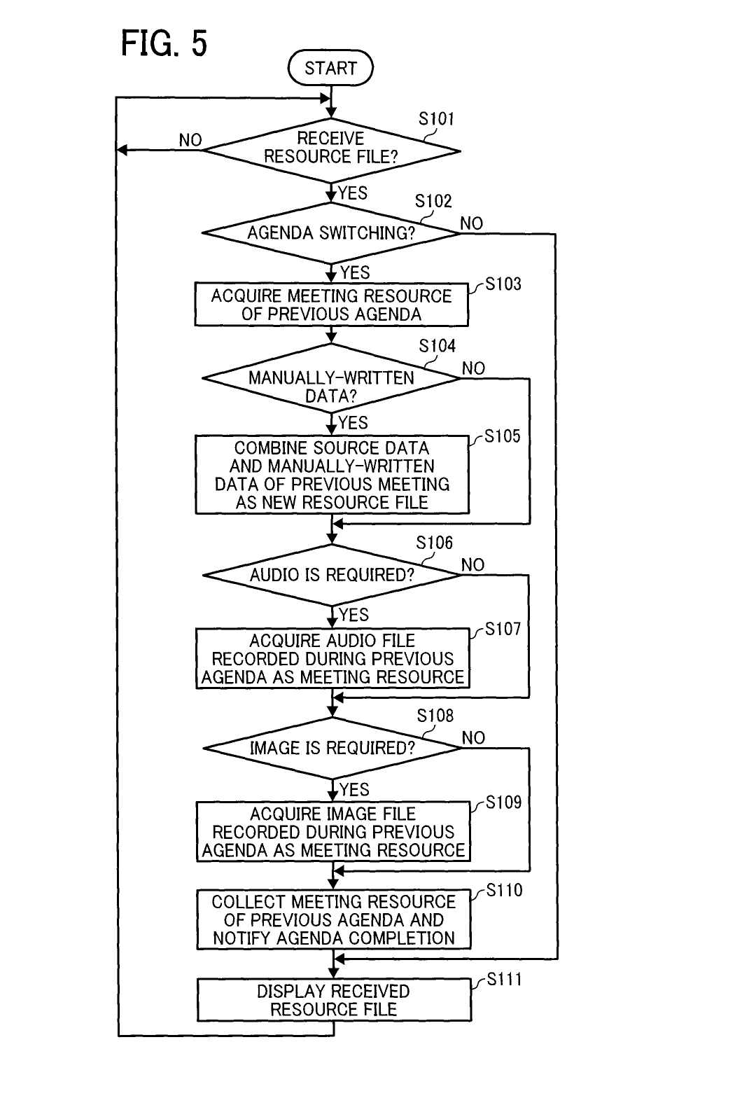

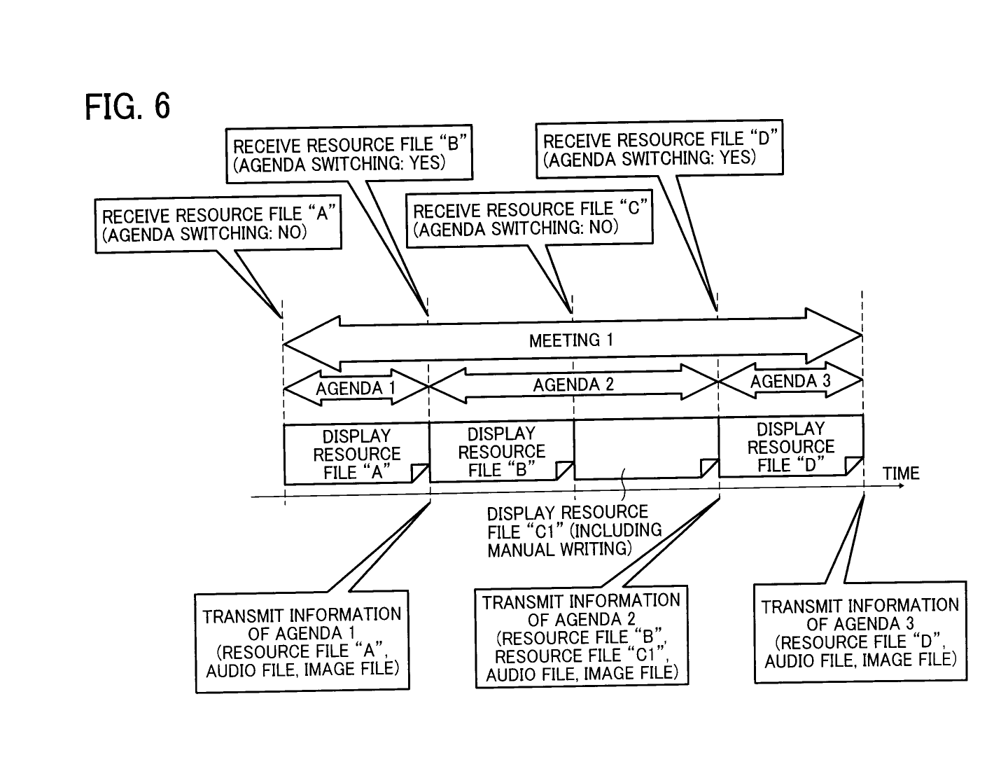

A description is given of a process executable by the electronic information board 110 according to one or more example embodiments with reference to FIGS. 5 and 6. FIG. 5 is a flowchart showing the steps of a process of detecting and notifying an agenda switching executable by the electronic information board 110.

The sequence of FIG. 5 starts, for example, when the electronic information board 110 is activated and participates a meeting. At step S101, the electronic information board 110 determines whether the electronic information board 110 receives a resource file. If it is determined that the electronic information board 110 does not receive the resource file (S101: NO), the sequence loops to step S101, and waits to receive a resource file. By contrast, if it is determined that the electronic information board 110 receives the resource file (S101: YES), the sequence proceeds to step S102.

At step S102, the agenda switching detection unit 222 of the electronic information board 110 determines whether a switching of agenda is received or detected based on the attached information attached to the received resource file. If it is determined that the switching of agenda is not received or detected (S102: NO), the sequence proceeds to step S111. At step S111, the display controller 214 of the electronic information board 110 displays data of the received resource file on the display or screen of the electronic information board 110, and the sequence loops to step S101.

By contrast, if it is determined that the switching of agenda is received or detected (S102: YES), the sequence proceeds to step S103. At step S103, the electronic information board 110 acquires a meeting resource used for the previous agenda from the file storage 218, and the sequence proceeds to step S104. At step S104, the electronic information board 110 further determines whether information is written manually on the display of the electronic information board 110. If it is determined that the information is written manually (S104: YES), the sequence proceeds to step S105. At step S105, the file generator 216 of the electronic information board 110 can combine original or source data of the resource file of the previous agenda, and the manually-written data to convert the original data of the resource files into a new resource file, and the sequence proceeds to step S106. If it is determined that the manually-written information does not exist (S104: NO), the sequence proceeds to step S106.

At step S106, the electronic information board 110 determines whether audio data is required to be transmitted. For example, the audio data is required to be transmitted when one or more speakers are required to be identified to determine the access right of each of the speakers, and when the audio data is to be added as a meeting resource. If it is determined that the audio data is required to be transmitted (S106: YES), the sequence proceeds to step S107.

At step S107, the audio recording unit 226 of the electronic information board 110 acquires an audio file, which is recorded during the previous agenda, as a meeting resource, and the sequence proceeds to step S108. If it is determined that the audio data is not required to be transmitted (S106: NO), the sequence proceeds to step S108.

At step S108, the electronic information board 110 determines whether an image data is required to be transmitted. For example, the image data is required to be transmitted when one or more writers are required to be identified to determine the access right of each writer, and when the image data is added as a meeting resource. The image data may include still image data and/or movie image data. If it is determined that the image data is required to be transmitted (S108: YES), the sequence proceeds to step S109.

At step S109, the image recording unit 228 of the electronic information board 110 acquires an image file, which is recorded during the previous agenda, as a meeting resource, and the sequence proceeds to step S110. If it is determined that the image data is not required to be transmitted (S108: NO), the sequence proceeds to step S110.

At step S110, the electronic information board 110 collects the meeting resource such as the resource file, the audio file, the image file acquired for the previous agenda as required, and transmits the collected meeting resource to the meeting management server 140 with an agenda completion notice. At step S111, the electronic information board 110 displays the currently-used resource file on the display of the electronic information board 110, and the sequence returns to step S101, and waits a next resource file.

FIG. 6 illustrates an example of relationships of information received by and transmitted from the electronic information board 110, and meetings and agendas according to one or more example embodiments. In an example case of FIG. 6, when a meeting 1 starts, a resource file “A” is transmitted from the mobile information terminal 170 to the electronic information board 110. The resource file “A” is not attached with the attached information indicating an agenda switching. Since the resource file “A” is transmitted right after the start of the meeting 1, an agenda 1 starts.

Then, at a timing of receiving a resource file “B” from the mobile information terminal 170, an agenda switching is detected because the resource file “B” is attached with the attached information indicating the agenda switching. Then, the electronic information board 110 transmits information indicating a completion of the agenda 1 (information of agenda 1), the resource file “A” used for the agenda 1, and the audio file and image file for the agenda 1, if required, to the meeting management server 140. Then, the display of the electronic information board 110 displays data of the newly received resource file “B”, and a new agenda 2 starts.

Then, at a timing of receiving a resource file “C” from the mobile information terminal 170, the display of the electronic information board 110 displays data of the received resource file “C” without switching the agenda because the resource file “C” is not attached with the attached information indicating the agenda switching. In this example case, information is written manually on the display of the electronic information board 110 when the resource file “C” is being displayed on the display. Then, at a timing of receiving a resource file “D” from the mobile information terminal 170, the agenda switching is detected because the resource file “D” is attached with the attached information indicating the agenda switching.

Then, the electronic information board 110 transmits information indicating a completion of the agenda 2 (information of agenda 2), the resource file “B” used during the agenda 2, a resource file “C1” (including manually-written information) converted form the received resource file “C”, and the audio file and image file for the agenda 2, if required, to the meeting management server 140. Then, the display of the electronic information board 110 displays data of the newly received resource file “D”, and a new agenda 3 starts.

As illustrated in FIG. 6, the agenda switching can be detected by the electronic information board 110 at a timing of receiving a resource file attached with the attached information indicating the agenda switching, and the meeting resource (e.g., resource file, audio file, image file) of each of the agendas can be transmitted to the meeting management server 140 when the agenda switching is detected.

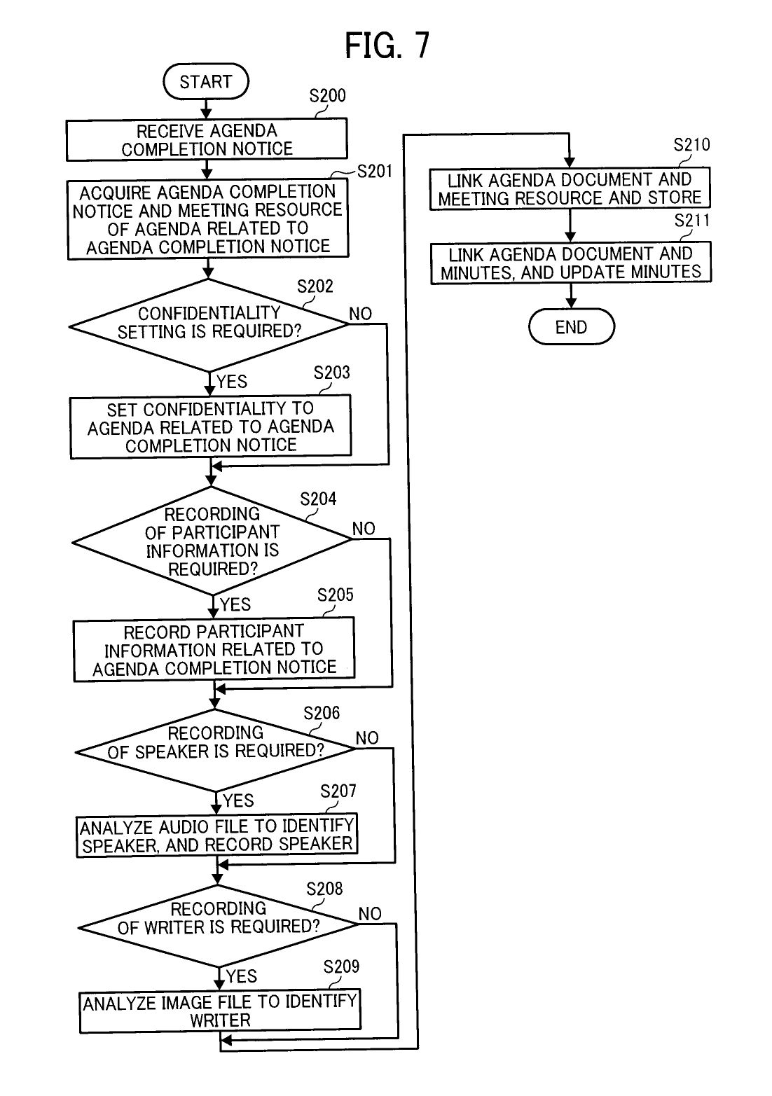

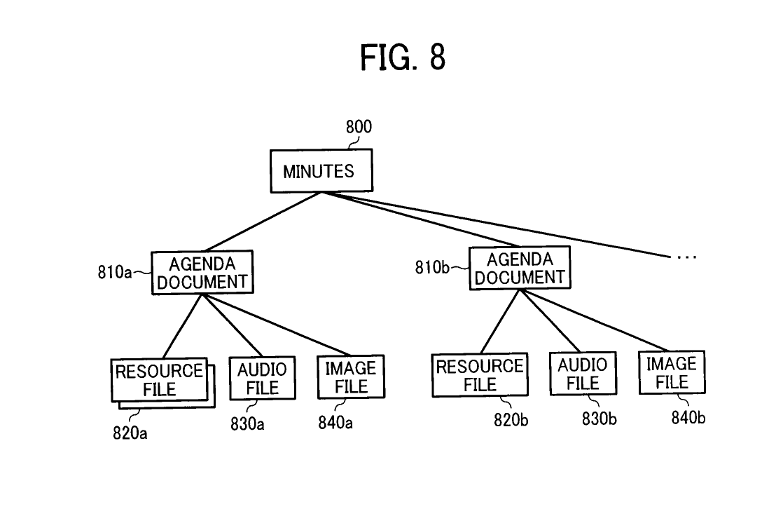

A description is given of a process executable by the meeting management server 140 with reference to FIGS. 7 and 8. FIG. 7 is a flowchart showing the steps of a process of meeting management executable by the meeting management server 140 according to one or more example embodiments.

The sequence of FIG. 7 starts, for example, when the meeting management server 140 receives an agenda completion notice from the electronic information board 110 at step S200. In this example case, it is assumed that a meeting is already started, and a minutes is generated. At step S201, the meeting management server 140 acquires the agenda completion notice, and a meeting resource of an agenda related to the agenda completion notice.

At step S202, the meeting management server 140 determines whether the confidentiality setting is required for the concerned agenda. The requirement of confidentiality setting can be determined based on an information security policy of an entity that uses the electronic meeting system 100, and types of meetings. In this example case, the requirement of confidentiality setting is determined based on a given criteria set for each meeting.

If it is determined that the confidentiality setting is required (S202: YES), the sequence proceeds to step S203. At step S203, the confidentiality setting unit 266 of the meeting management server 140 performs the confidentiality setting to the agenda related to the agenda completion notice, and the sequence proceeds to step S204.

The confidentiality setting can be performed as follows, but not limited thereto. For example, a default confidentiality level set at the start of a meeting can be used without changing the confidentiality level; a high confidentiality level can be set to an agenda including a resource file transmitted from a specific person; and a high confidentiality level can be set to an agenda including a specific text (e.g., “secret”), which can be detected by the optical character recognition (OCR) processing and text mining to a received resource file.

If it is determined that the confidentiality setting is not required (S202: NO), the sequence proceeds to step S204. At step S204, the meeting management server 140 determines whether a recording of participants is required. The recording of participants is required when the participant information of each of agendas is used to determine the access right to each of the agendas, and when the recording of participant information of each of the agendas is required for generating a minutes. If it is determined that the recording of participants is required (S204: YES), the sequence proceeds to step S205.

At step S205, the participant management unit 256 of the meeting management server 140 performs the recording of participants that have participated the concerned agenda related to the agenda completion notice, and the sequence proceeds to step S206. If it is determined that the recording of participants is not required (S204: NO), the sequence proceeds to step S206.

At step S206, the meeting management server 140 determines whether a recording of speaker is required. The recording of speaker is required when speaker information of each of the agendas is used to determine the access right to each of the agenda. If it is determined that the recording of speaker is required (S206: YES), the sequence proceeds to step S207. At step S207, the audio analyzer 246 of the meeting management server 140 analyzes an audio file corresponding to the concerned agenda related to the agenda completion notice to identify one or more speakers for the concerned agenda, performs the recording of one or more speakers, and the sequence proceeds to step S208. If it is determined that the recording of speaker is not required (S206: NO), the sequence proceeds to step S208.

At step S208, the meeting management server 140 determines whether the recording of writer is required. The recording of writer is required when writer information of each of the agendas is used to determine the access right to each of the agendas. If it is determined that the recording of writer is required (S208: YES), the sequence proceeds to step S209. At step S209, the image analyzer 250 of the meeting management server 140 analyzes an image file corresponding to the concerned agenda related to the agenda completion notice to identify one or more writers for the concerned agenda, performs the recording of one or more writers, and the sequence proceeds to step S210. If it is determined that the recording of writer is not required (S208: NO), the sequence proceeds to step S210.

At step S210, the agenda document generation unit 264 of the meeting management server 140 generates an agenda document, and stores the agenda document, and the meeting resource by associating or linking the agenda document and the meeting resource. At step S211, the meeting management server 140 updates the minutes by associating or linking the generated agenda document and the current minutes, and the sequence competes. Then, the meeting management server 140 waits a next agenda completion notice.

A description is given of a management structure of minutes, agenda documents, meeting resources managed by the meeting management server 140 with reference to FIG. 8. As illustrated in FIG. 8, a minutes 800 is generated for each of the meetings, and one or more agenda documents 810a and 810b can be generated for each of the agendas using the minutes 800 as a parent. Further, one or more meeting resources such as resource files 820a and 820b, audio files 830a and 830b, and image files 840a and 840b used for each of the agendas can be stored using the agenda documents 810a and 810b as a parent.

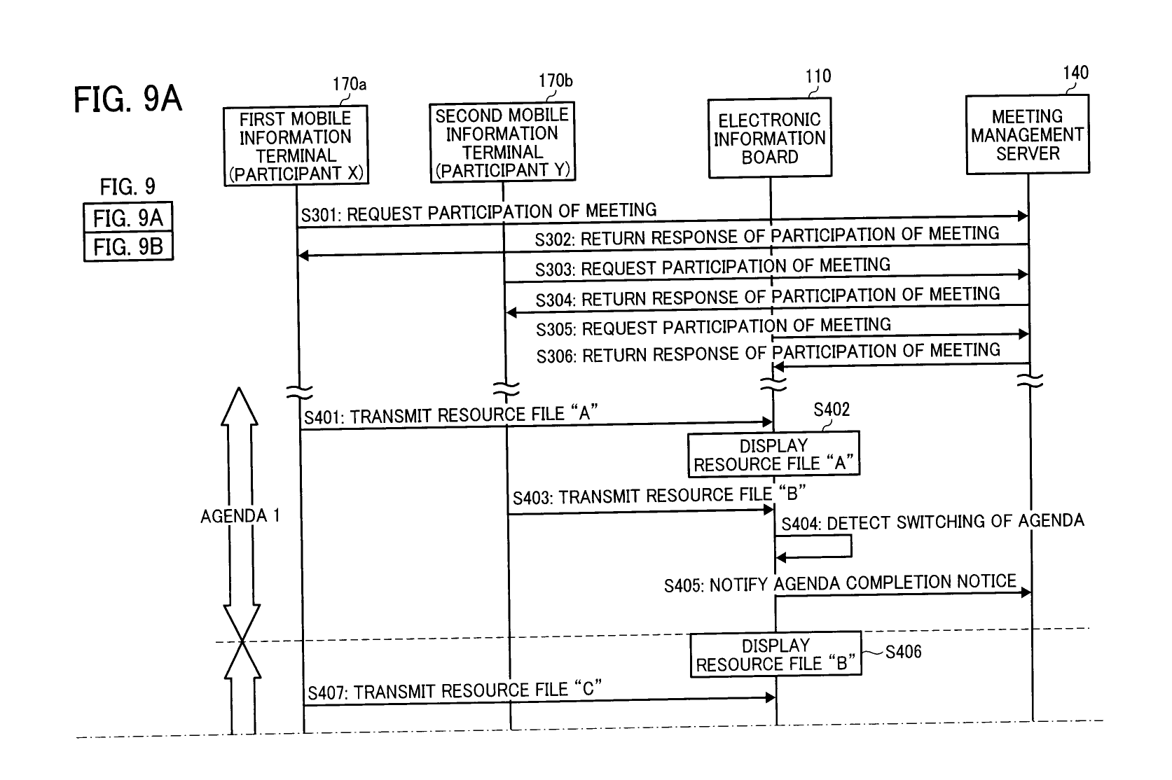

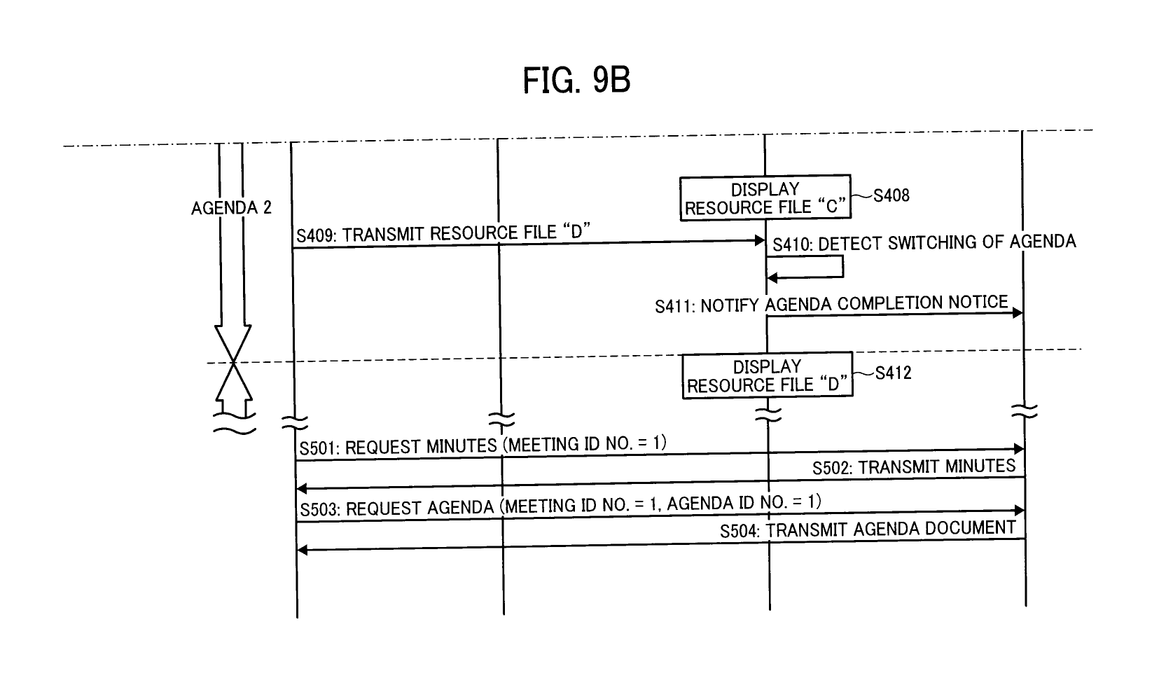

A description is given of communication flows among the apparatuses in the electronic meeting system 100 with reference to FIGS. 9 to 12. FIG. 9 (FIGS. 9A and 9B) is an example of communication flows of data between the apparatuses in the electronic meeting system without setting the confidentiality level.

In an example case of FIG. 9, a pre-meeting phase is initiated. At first, each meeting participant transmits a participation request to a meeting to the meeting management server 140 before the start of the meeting. In an example case of FIG. 9, the meeting is held by two participants X and Y, one electronic information board 110, and one meeting management server 140. A first mobile information terminal (mobile information terminal 170a) and a second mobile information terminal (mobile information terminal 170b) are used by two participants to transmit a request of participation to the meeting, and the electronic information board 110 transmits a request of participation to the meeting to the meeting management server 140 (S301, S303, S305). Then, the meeting management server 140 manages the participants, and returns a response (S302, S304, S306). The participating meeting can be designated by users by designating a meeting identifier (ID), a meeting number, or by selecting a meeting from a meeting list.

When the pre-meeting phase is completed, a meeting-in-progress phase is initiated. During the meeting, one or more meeting participants upload one or more resource files stored in each of the mobile information terminals 170 to the electronic information board 110 if required, and the electronic information board 110 displays the resource files on the display as required.

In an example case of FIG. 9, the resource file “A” transmitted from the participant X (S401) is displayed on the electronic information board 110 during the agenda 1 (S402), and the resource file “B” transmitted from the participant Y (S403) and the resource file “C” transmitted from the participant X (S407) are displayed on the electronic information board 110 during the agenda 2 (S406, S408), in which the resource file “B” transmitted from the participant Y (S403) and the resource file “D” transmitted from the participant X (S409) include the meta data indicating the agenda switching. Therefore, when the resource file “B” and the resource file “D” are received respectively, the electronic information board 110 detects a completion of the agenda 1 and the agenda 2 respectively (S404, S410), and respectively notifies the completion of the agenda 1 and the agenda 2 to the meeting management server 140 (S405, S411).

In the above description, the meeting resource is transmitted with the agenda completion notice from the electronic information board 110 to the meeting management server 140 when the agenda completion is detected. However, the transmission timing of the meeting resource from the electronic information board 110 to the meeting management server 140 is not limited hereto. For example, in another configuration, the meeting resource can be transmitted at a timing of completing a use of each resource file on the electronic information board 110.

In an example case of FIG. 9, the resource file “B” transmitted from the participant Y, and the resource file “D” transmitted from the participant X include the meta data indicating the agenda switching, with which the agenda switching can be determined. Further, the agenda switching can be determined using sender identification (ID) information by performing the similar process. Specifically, when the electronic information board 110 receives a resource file from a chairperson (user), the electronic information board 110 can determine that the agenda switching occurs, and can notify a completion of the agenda to the meeting management server 140. In this configuration, when the resource file is transmitted from the chairperson while no resource files is yet displayed on the electronic information board 110, the electronic information board 110 can determine that the resource file is transmitted at a timing of starting the meeting, and thereby the electronic information board 110 does not notify an agenda completion notice.

When the meeting-in-progress phase is completed, a post-meeting phase is initiated. When the meeting management server 140 receives a request of a minutes from one or more meeting participants (S501), the meeting management server 140 provides the minutes of the concerned meeting to the one or more meeting participants (S502). The minutes of the meeting includes, for example, a list of agendas discussed in the meeting. By using the displayed agenda list, each of the meeting participants can request the agenda documents and related meeting resources. When the meeting management server 140 further receives an agenda request from the one or more meeting participants (S503), the meeting management server 140 provides the agenda documents and the used meeting resources of the concerned agenda to one or more the meeting participants (S504).

A timing when the meeting management server 140 receives the request of minutes and agenda, and a timing when the meeting management server 140 provides the requested minutes and agenda is not limited to after the meeting, but can be during the meeting-in-progress phase, in which the meeting participants can refer the meeting resource, which was displayed on the electronic information board 110 but is not displayed currently, during the meeting.

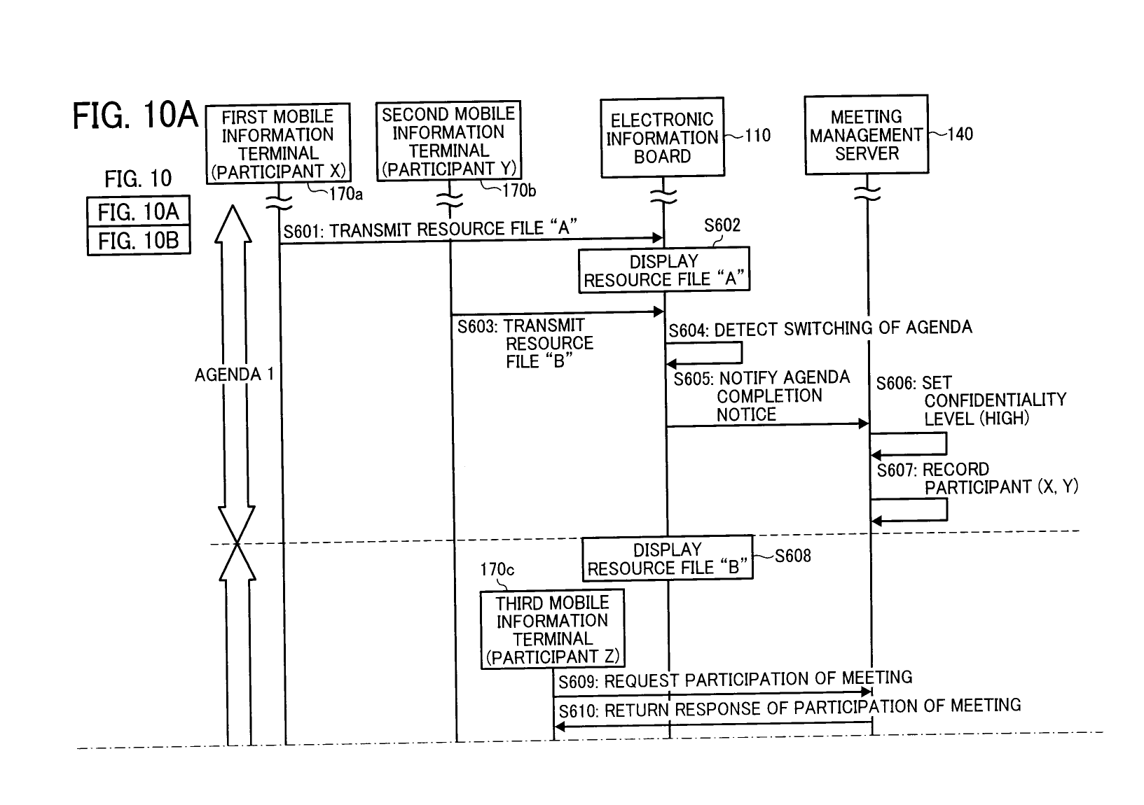

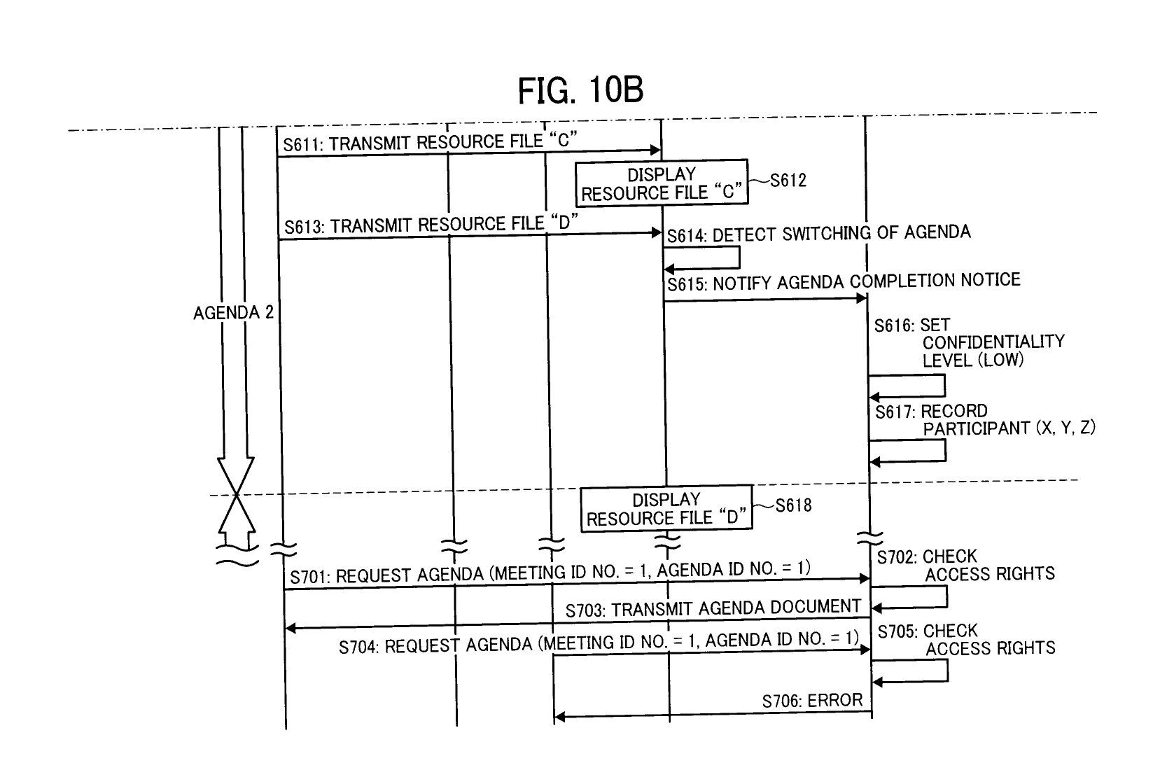

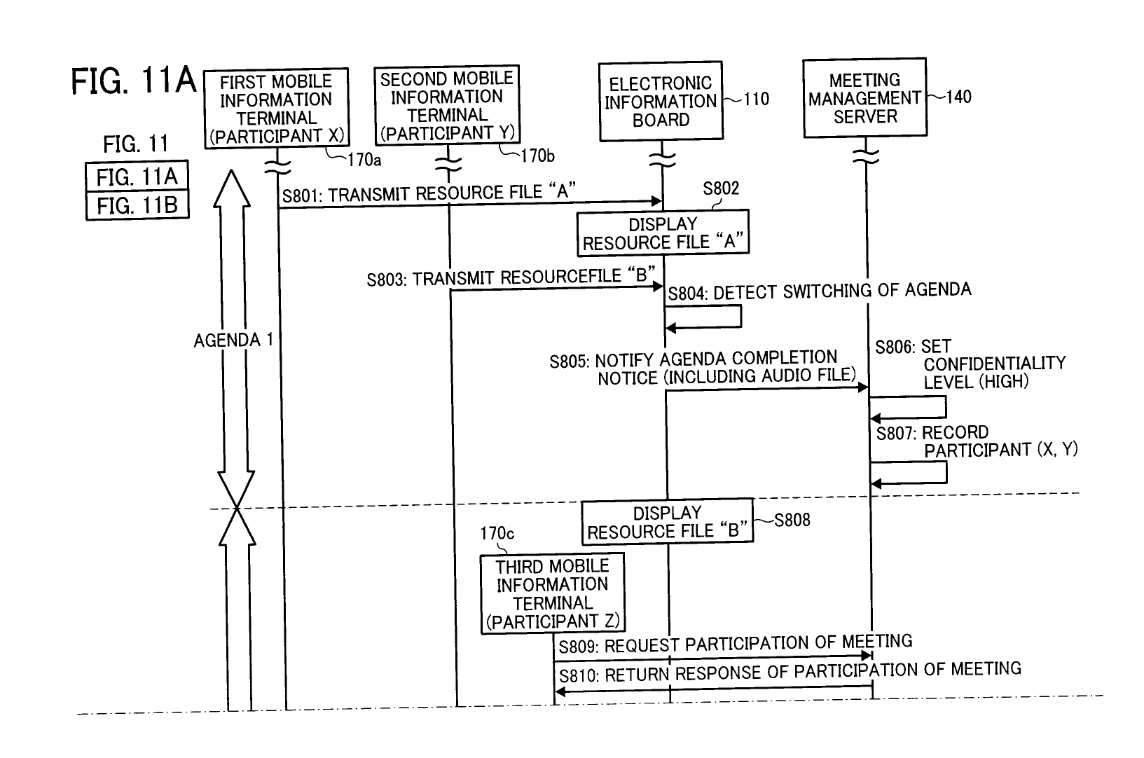

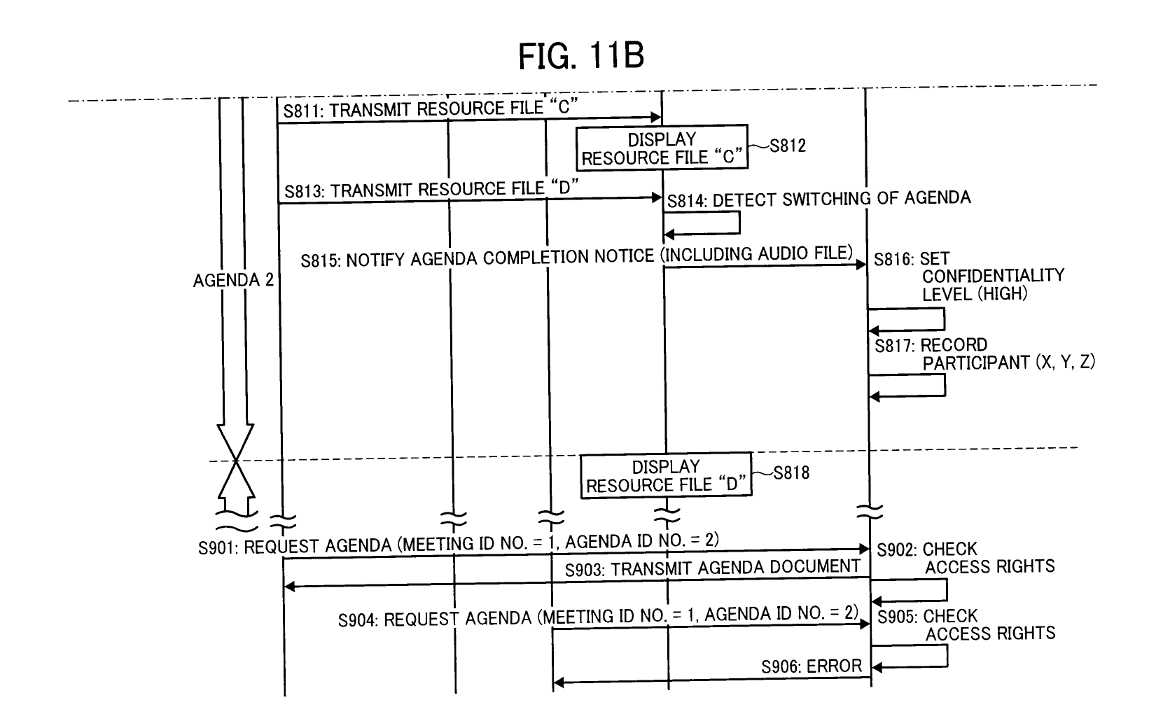

Compared to a case without setting the confidentiality level described with reference to FIG. 9, FIGS. 10 and 11 are communication flows of data between apparatuses with setting the confidentiality level. In FIGS. 10 and 11, the pre-meeting phase explained in FIG. 9 is already completed, and thereby omitted.

FIG. 10 (FIGS. 10A and 10B) is an example of communication flows of data between apparatuses with setting the confidentiality level, in which the access right is granted only to one or more participants of an agenda. In an example case of FIG. 10, two participants X and Y (mobile information terminals 170a and 170b) participate a meeting from the beginning, and then a participant Z (mobile information terminal 170c) participates from the middle of the meeting (S609, S610), and thereby three participants X, Y, and Z participate the meeting at last.

When the confidentiality setting is performed, the meeting management server 140 determines a confidentiality level of the concerned agenda when receiving an agenda completion notice (S605, S615), and sets the confidentiality level (S606, S616). In an example case of FIG. 10, the agenda 1 is set with a confidentiality level of “high,” and the agenda 2 is set with a confidentiality level of “low.” When the confidentiality level of the agenda 1 is set, the meeting management server 140 records the participants X and Y for the agenda 1 (S607) because the participants X and Y have participated the agenda 1 in the meeting. Further, when the confidentiality level of the agenda 2 is set, the meeting management server 140 records the participants X, Y, and Z for the agenda 2 (S617) because the participants X, Y, and Z have participated the agenda 2 in the meeting.

As to the post-meeting phase, the meeting management server 140 receives an agenda request from one or more meeting participants (S701, S704). If the concerned agenda is set with the confidentiality level of “high,” the meeting management server 140 checks the access right of an agenda requester to the concerned agenda (S702, S705), and then provides the agenda document and the used meeting resource of the concerned agenda to the one or more meeting participants. In an example case of FIG. 10, since the agenda 1 is set with the confidentiality level of “high,” and the agenda 2 is set with the confidentiality level of “low,” the meeting management server 140 checks the access right when an agenda request to the agenda 1 is received or detected.

As to the check of the access right, the meeting management server 140 checks whether the agenda requester has participated the concerned agenda in the meeting. The meeting management server 140 provides the meeting resource to the agenda requester that has participated the concerned agenda, but notifies an error of the access right to the agenda requester that did not participate the concerned agenda. In an example case of FIG. 10, two participants X and Y have participated the agenda 1 and the agenda 2, and the participant Z has participated only the agenda 2. Therefore, the meeting management server 140 determines that the participant X has the access right to the agenda 1 (S702), and provides the agenda document and the meeting resource (S703), but determines that the participant Z has no access right to the agenda 1 (S705), and notifies the error of the access right to the participant Z (S706).

In an example case of FIG. 10, one or more participants of each of the agendas are recorded. The meeting management server 140 can check the access right based on the recorded one or more participants that have participated each of the agendas. Further, in another configuration, one or more senders of resource files can be recorded for each of the agendas, and then the meeting management server 140 can check the access right based on information whether an agenda requester is included in the senders of resource files for one agenda by performing the similar process.

FIG. 11 (FIGS. 11A and 11B) is an example of flow of data between apparatuses with setting the confidentiality level, in which the access right is granted only to one or more speakers of an agenda using speaker recognition technologies. When the speaker recognition technologies are used, a registration of voice print of participants is required. If participants not registered with a voice print exist in a meeting, the registration of voice print can be activated when a request of meeting participation is received or detected.

In an example case of FIG. 11, two participants X and Y (mobile information terminals 170a and 170b) participate a meeting from the beginning, and then the participant Z (mobile information terminal 170c) participates from the agenda 2 of the meeting. The electronic information board 110 can record an audio file for each of agendas in the meeting to determine one or more speakers during each of the agendas, and notifies an agenda completion notice to the meeting management server 140 with the audio file (S805, S815).

Further, similar to FIG. 10, when the confidentiality setting is performed in the meeting-in-progress phase, the meeting management server 140 sets a confidentiality level of the concerned agenda when receiving the agenda completion notice (S606, S616). In an example case of FIG. 11, the agenda 1 and agenda 2 are set with the confidentiality level of “high.” After setting the confidentiality level, one or more speaker is identified and recorded. For example, as to the agenda 1, the participants X and Y are identified and recorded as the speakers based on the received audio file (S807), and as to the agenda 2, the participants X and Z are recorded as the speakers, but the participant Y is not recorded as the speaker (S817).

The meeting management server 140 determines whether the agenda requester spoke during the concerned agenda when a request of the agenda set with the confidentiality level of “high” is received or detected. In an example case of FIG. 11, the three participants X, Y and Z have participated the agenda 2, in which two participants X and Z spoke but the participant Y did not spoke for the agenda 2. Therefore, the meeting management server 140 accepts the request of the agenda 2 by the participant X (S902), and provides an agenda document and a meeting resource to the participant X (S903), but notifies an error of the access right to the participant Y (S906) even if the participant Y requests the agenda 2 (S904).

The audio file registered in the meeting management server 140 can be used other than the identification of speaker. For example, the audio file can be stored as a meeting resource, and can be provided as the meeting resource when a request of an agenda is received or detected.

In an example case of FIG. 11, the speaker of agenda can be identified and recorded based on the received audio file, and then the meeting management server 140 can check the access right based on whether the agenda requester is the speaker of the agenda.

Further, similar to the audio file, an image file can be used. For example, an image file (image data) captured during an agenda can be compared with the registered face data to identify and record one or more writers of the agenda, and the meeting management server 140 can check the access right based on whether one or more participants are writers for the concerned agenda by performing the similar process. When the face recognition technologies are used, the registration of face data of participants is required. If participants not registered with face data exist in a meeting, the registration of face data can be activated when a request of meeting participation is received, in which a picture of face is captured on site, and face data is extracted and registered when the request of the meeting participation is received or detected. Further, similar to the audio file, the image file registered in the meeting management server 140 can be used other than the identification of writer. For example, the image file can be stored as a meeting resource, and can be provided as the meeting resource when a request of agenda is received or detected.

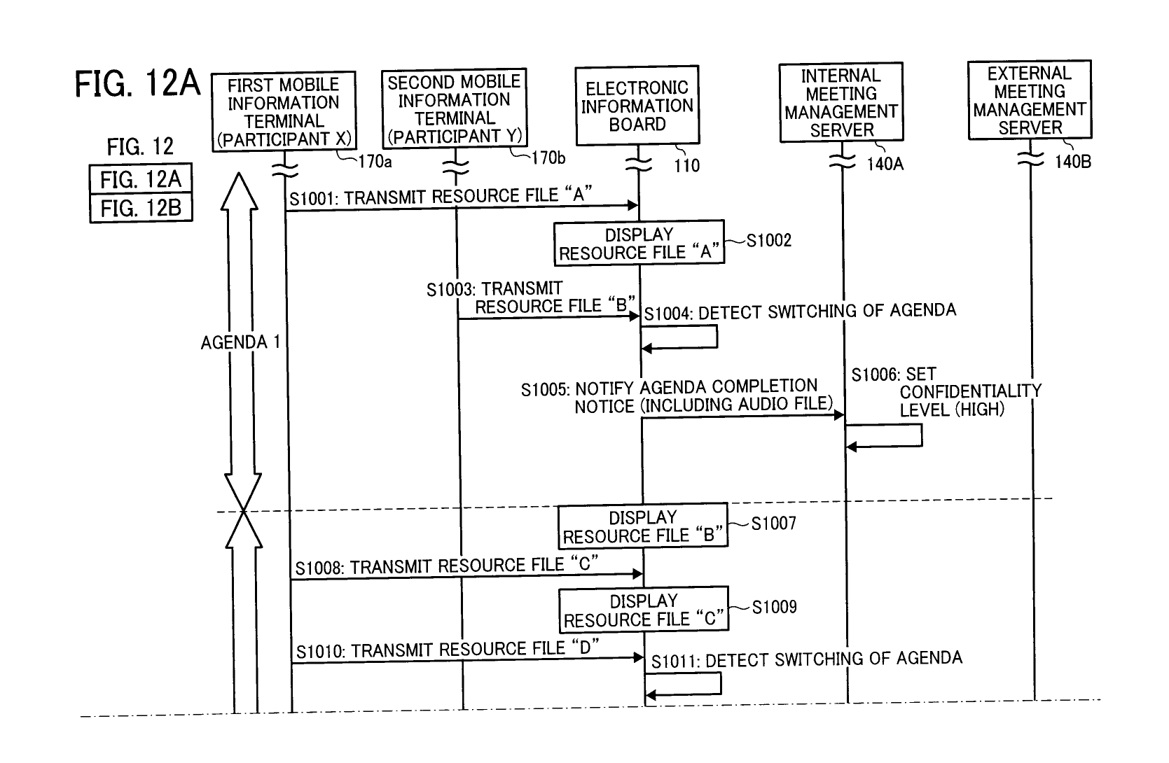

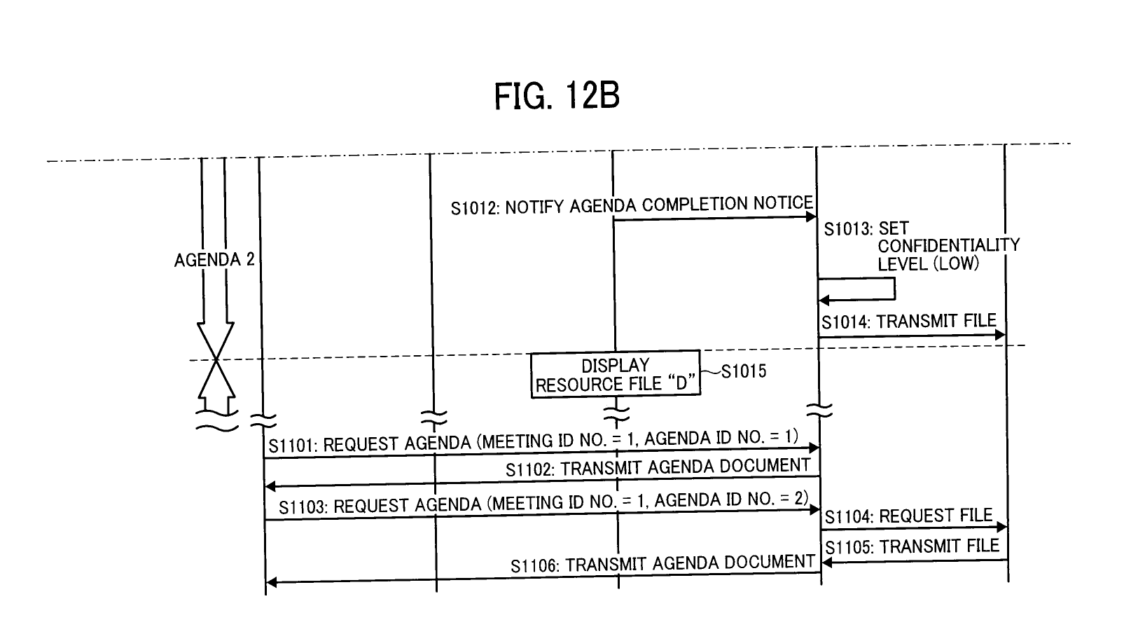

FIGS. 10 and 11 describe example cases that data can be stored at any one of storing destination units without consideration to the confidentiality setting. FIG. 12 (FIGS. 12A and 12B) is an example of communication flows of data between apparatuses with setting the confidentiality level, in which a storing destination unit can be selectively set depending on the confidentiality setting. In FIG. 12, the pre-meeting phase explained in FIG. 9 is already completed, and thereby omitted. In an example case of FIG. 12, the internal meeting management server 140A that manages meetings as a main server has lower openness to the public while another server such as the external meeting management server 140B has higher openness to the public, in which the internal meeting management server 140A can manage meeting participants, and receive an agenda completion notice from the electronic information board 110.

When the meeting management server 140 receives the agenda completion notice (S1005, S1012), the meeting management server 140 sets a confidentiality level of the concerned agenda (S1006, S1013), in which the meeting management server 140, used as a storing destination unit, can be selectively changed based on the confidentiality level of the concerned agenda. For example, a meeting resource of an agenda set with the high confidentiality level is stored in the internal meeting management server 140A having the lower openness to the public (i.e., higher confidentiality level) whereas a meeting resource of an agenda set with the low confidentiality level is transmitted and stored in the external meeting management server 140B having the higher openness to the public (i.e., lower confidentiality level) (S1014).

When a request of each of agendas is received or detected in the post-meeting phase, and if the internal meeting management server 140A does not store information of the requested concerned agenda in the file storage 244 of the internal meeting management server 140A, the internal meeting management server 140A can receive a meeting resource related to the concerned agenda from the external meeting management server 140B, and provide the meeting resource, received from the external meeting management server 140B, to an agenda requester. In this configuration, the mobile information terminal 170 used by the agenda requester does not recognize a real storing destination unit of the meeting resource, which means the mobile information terminal 170 recognizes that the mobile information terminal 170 has received the information of the requested concerned agenda from the internal meeting management server 140A although the internal meeting management server 140A does not store the information of the requested concerned agenda.

In an example case of FIG. 12, when a request of the agenda 1 set with the high confidentiality level is received, the internal meeting management server 140A provides a meeting resource stored in the file storage 244 of the internal meeting management server 140A to the agenda requester (S1102), and when a request of the agenda 2 set with the low confidentiality level is received, the internal meeting management server 140A receives a meeting resource stored in the external meeting management server 140B (S1104, S1105), and provides the received meeting resource to the agenda requester (S1106).

The above described information processing system, information processing apparatus, and program can detect the agenda switching, and can generate a minutes of meeting by automatically marking a boundary between agendas discussed in a meeting based on the detection of the agenda switching.

As to the above described one or more example embodiments, the electronic meeting system 100 can detect the agenda switching during a meeting based on meta data attached to a resource file (resource data) or sender information transmitted from the mobile information terminal 170. In this configuration, meeting participants can notify the electronic meeting system 100 that the agenda switching occurs easily without performing a special operation such as pushing a dedicated switch to notify the agenda switching, which means the agenda switching can be automatically notified to the electronic meeting system 100 by transmitting a resource file (resource data).

Further, as to the above described electronic meeting system 100, the access right to a meeting resource of an agenda set with the high confidentiality level can be granted to one or more participants that have participated the concerned agenda in a meeting, with which the access right to the meeting resource is not granted to persons not participating the concerned agenda such as persons participating the meeting from the middle of the meeting but not participating the concerned agenda, and persons exiting from the meeting in the middle of the meeting and thereby not participating the concerned agenda.

Further, the access right to a meeting resource of an agenda set with the high confidentiality level can be granted only to participants participating the concerned agenda, speakers of the concerned agenda, writers that write information to the electronic information board 110, and senders that transmit resource files (resource data) during the concerned agenda in a meeting, in which the access right to the meeting resource can be granted only to the participants participating the agenda explicitly.

Further, as to the above described electronic meeting system 100, the confidentiality level can be set for each agenda instead of each meeting resource. Therefore, even if one meeting resource alone has a lower confidentiality level, by combining the meeting resource having the lower confidentiality level with other meeting resources having the higher confidentiality level as a group of meeting resources, the group of meeting resources can be set with the higher confidentiality level in line with the confidentiality level of the whole context of the meeting resources, and thereby the access right can be set in line with the confidentiality level of the agenda.

The above described information processing system, information processing apparatus, and program can detect and record the agenda switching efficiently, and can generate the minutes by marking a boundary between agendas based on the detection of the agenda switching.

The present invention can be implemented in any convenient form, for example using dedicated hardware platform, or a mixture of dedicated hardware platform and software. Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions. The illustrated server apparatuses are only illustrative of one of several computing environments for implementing the embodiments disclosed herein. For example, in some embodiments, any one of the information processing apparatus may include a plurality of computing devices, e.g., a server cluster, that are configured to communicate with each other over any type of communication links, including a network, a shared memory, etc. to collectively perform the processes disclosed herein.

The computer software can be provided to the programmable device using any storage medium or carrier medium such as non-volatile memory for storing processor-readable code such as a floppy disk, a flexible disk, a compact disk read only memory (CD-ROM), a compact disk rewritable (CD-RW), a digital versatile disk read only memory (DVD-ROM), DVD recording only/rewritable (DVD-R/RW), electrically erasable and programmable read only memory (EEPROM), erasable programmable read only memory (EPROM), a memory card or stick such as USB memory, a memory chip, a mini disk (MD), a magneto optical disc (MO), magnetic tape, a hard disk in a server, a flash memory, Blu-ray disc (registered trademark), SD card, a solid state memory device or the like, but not limited these. Further, the computer software can be provided through communication lines such as electrical communication line. Further, the computer software can be provided in a read only memory (ROM) disposed for the computer. The computer software stored in the storage medium can be installed to the computer and executed to implement the above described processing. The computer software stored in the storage medium or apparatus of an external apparatus can be downloaded and installed to the computer via a network to implement the above described processing.

The hardware platform includes any desired kind of hardware resources including, for example, a central processing unit (CPU), a random access memory (RAM), and a hard disk drive (HDD). The CPU may be implemented by any desired kind of any desired number of processors. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

In the above-described example embodiment, a computer can be used with a computer-readable program, described by object-oriented programming languages such as C, C++, C#, Java (registered trademark), JavaScript (registered trademark), Perl, Ruby, or legacy programming languages such as machine language, assembler language to control functional units used for the apparatus or system. For example, a particular computer (e.g., personal computer, workstation) may control an information processing apparatus or an image processing apparatus such as image forming apparatus using a computer-readable program, which can execute the above-described processes or steps. In the above-described embodiments, at least one or more of the units of apparatus can be implemented as hardware or as a combination of hardware/software combination. Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

Numerous additional modifications and variations for the communication terminal, information processing system, and information processing method, a program to execute the information processing method by a computer, and a storage or carrier medium of the program are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. An information processing system configurable with one or more information processing apparatuses, the information processing system comprising:
a minutes manager to manage a minutes;
a communication controller to control a reception of loading data receivable from an information terminal, the loading data attachable with attached information;
a display controller to control displaying of the loading data received by the communication controller on a display;
an agenda switching detector to detect an agenda switching for marking an agenda boundary between agendas based on the attached information attachable to the loading data received by the communication controller; and
an agenda information generator to generate agenda information for the agenda marked with the agenda boundary by the agenda switching detector, the generated agenda information of the agenda-boundary-marked agenda associable with the minutes managed by the minutes manager.

2. The information processing system of claim 1, further comprising:
a confidentiality setting unit to set confidentiality property to the agenda marked with the agenda boundary by the agenda switching detector;
a storing destination unit to store one or more resource data used for the agenda-boundary-marked agenda in association with the agenda information generated by the agenda information generator; and
a request processing unit to receive an acquiring request of the one or more resource data stored in the storing destination unit from an agenda requester, and to provide the one or more resource data of the agenda-boundary-marked agenda when the agenda requester is determined to have an access right to the agenda-boundary-marked agenda.

3. The information processing system of claim 2, further comprising:
an audio recorder to record audio during discussion of an agenda to generate audio data; and
an audio analyzer to analyze the audio data of the agenda to identify a speaker that speaks during discussion of the agenda,
wherein the request processing unit determines the access right to the agenda based on information of the identified speaker during discussion of the agenda requested by the agenda requester.

4. The information processing system of claim 2, further comprising:
an image recorder to record image during discussion of an agenda to generate image data; and
an image analyzer to analyze the image data of the agenda to identify a writer that writes data onto the display during discussion of the agenda,
wherein the request processing unit determines the access right to the agenda based on information of the identified writer of the agenda requested by the agenda requester.

5. The information processing system of claim 2, further comprising:
a participant manager to manage participants participating in discussion of the agenda in a meeting,
wherein the request processing unit determines the access right to the agenda based on information of the participants of the agenda requested by the agenda requester.

6. The information processing system of claim 2, wherein the request processing unit determines the access right to an agenda based on information of a sender that transmits the loading data for the agenda requested by the agenda requester.

7. The information processing system of claim 2, wherein the storing destination unit to store one or more resource data used for an agenda is selectively set depending on the confidentiality property set to the agenda by the confidentiality setting unit.

8. The information processing system of claim 7, wherein the storing destination unit includes a first storing destination unit and a second storing destination unit,
the first storing destination unit has a storage area to store resource data of an agenda set with a first confidentiality level, and
the second storing destination unit has a storage area to store resource data of an agenda set with a second confidentiality level lower than the first confidentiality level, and
openness to the public of the storage area of the first storing destination unit is lower than openness to the public of the storage area of the second storing destination unit.

9. The information processing system of claim 1, wherein the attached information is meta data attachable to the loading data.

10. The information processing system of claim 1, wherein the attached information is sender identification information used for identifying a sender of the loading data.

11. The information processing system of claim 1, wherein the communication controller, the display controller, and the agenda switching detector are disposable in an information processing apparatus that outputs image data to a display apparatus that displays an image,
each of the minutes manager and the agenda information generator are disposable in any one of the information processing apparatuses, each of the information processing apparatuses useable as a server for managing one or more meetings, and
the information processing apparatus that outputs the image data includes a notifying unit to notify an agenda switching and resource data related to an agenda to the server in response to the detection of agenda switching by the agenda switching detector.

12. An information processing system configurable with one or more information terminals and one or more information processing apparatuses, comprising:
a minutes manager to manage a minutes;
a communication controller to control a reception of loading data from the one or more information terminals, the loading data attachable with attached information;
a display controller to control displaying of the loading data received by the communication controller on a display;
an agenda switching detector to detect an agenda switching for marking an agenda boundary between agendas based on the attached information attachable to the loading data received by the communication controller; and
an agenda information generator to generate agenda information for the agenda marked with the agenda boundary by the agenda switching detector, the generated agenda information of the agenda-boundary-marked agenda associable with the minutes managed by the minutes manager,
wherein the minutes manager, the communication controller, the display controller, the agenda switching detector, and the agenda information generator are operable on the one or more information processing apparatuses.

13. The information processing system of claim 12, wherein the information terminal includes an assignment unit to assign the attached information to the loading data when the information terminal transmits the loading data.

14. An information processing apparatus comprising:
a communication controller to control a reception of loading data from an information terminal, the loading data attachable with attached information;
a display controller to control displaying of the loading data received by the communication controller on a display;
an agenda switching detector to detect an agenda switching for marking an agenda boundary between agendas based on the attached information attachable to the loading data received by the communication controller; and
a notifying unit to notify the detected agenda switching to a server when the agenda switching detector detects the agenda switching,
wherein the server generates agenda information of the agenda-boundary-marked agenda, and associates the generated agenda information with a minutes for managing the generated agenda information.

15. The information processing apparatus of claim 14, wherein the information processing apparatus is an electronic information board including a display to display the loading data, and an input apparatus to input data, related to the loading data, to the display.
